(19) United States
(12) Patent Application Publication
(10) Pub. No.: US 2006/0149845 A1
(43) Pub. Date: Jul. 6, 2006

(54) Managed quality of service for users and applications over shared networks

(75) Inventors: Jay Malin, Lincolnshire, IL (US); Matthew Tooley, Chicago, IL (US); Aleksey Beregov, Palatine, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Xinnia Technology, LLC, Deerfield, IL (US)

(21) Appl. No.: 11/027,545

(22) Filed: Dec. 30, 2004

(51) Int. Cl. G06F 15/16

(52) U.S. Cl. 709/228

(57) ABSTRACT

Systems and methods are described for effectively managing the quality of service provided to subscribers in a shared network on a per-application, per-user basis. A system QoS proxy, sitting on a subscriber's computing device or on a web content server, captures network calls made by an application for a subscriber and uses locally stored quality profiles to determine if a request for high-quality communications should be made. If so, the QoS proxy requests QoS from a central application manager, which dedicates a high-quality communications session to the subscriber's application, and causes the subscriber to be billed appropriately.

### FIELD OF THE INVENTION

This invention pertains generally to the field of computer networks and more particularly to the area of requesting and managing high-quality communications for applications over shared networks.

### BACKGROUND OF THE INVENTION

Over the past several years, an increasing number of computer users in the United States have subscribed to high-speed (“Broadband”) Internet. As a result, network providers of these Broadband services are beginning to deploy advanced Internet services such as Voice over Internet Protocol (VoIP), Internet-based video-on-demand, on-line computer games, and business services. Because of the network demands from these services, there is a recognized potential for congestion resulting from oversubscription, thereby leading to churn and lost revenues.

This problem can be alleviated by managing the Internet traffic so that each subscriber obtains the quality of service (QoS) necessary to ensure these new services perform well. The Broadband cable industry has recognized the importance of maintaining subscriber satisfaction and, via its standards body, CableLabs, has specified a policy-based technology platform for guaranteeing QoS over the hybrid fiber-coax (HFC) network. This specification, called PacketCable Multimedia (PCMM), is intended to empower service providers to differentiate data flow to individual subscribers, thereby enabling a whole new class of “network aware” services.

The recent PCMM specification opens the door for multiple system operators (MSOs) such as cable companies to increase the overall value of their high-speed cable networks. Subscribers are now able to enjoy richer multimedia content in the home or office and benefit from packet-switched technologies such as VoIP and video telephone. By differentiating data flow to these subscribers on-demand, service providers can potentially maximize revenue from the content riding on their networks. PCMM further enables service providers to tap into the market for small and medium business telephone and data communication services. Until recently, this market was served only by dedicated lines capable of offering the service guarantees that can now be offered by Broadband cable.

This technology can be best exploited by making applications “network aware,” meaning that individual services and applications can dynamically signal their QoS requirements to the cable modem termination system (CMTS). Historically, there have been only two major approaches by which applications were made “network aware,” namely integrating “network awareness” into application software, and deep packet inspection hardware. The network infrastructure of broadband cable has not been capable of discriminating data flows based upon each application or content's QoS requirements, thus preventing applications from becoming truly “network aware”. Further, no dynamic processes have existed for managing QoS, thus network resources could not be re-allocated when the data flow requirements were no longer required by an application, and therefore the value of the network's data capacity was not maximized. Previous software vendors have tried unsuccessfully to capture policy-based QoS into their applications by embedding network traffic management; however these efforts failed due to a lack of support by the network infrastructure.

One unsuccessful method is an integrated application-oriented approach. This method requires every application developer to make their software “network aware” by including QoS features within their application software either on the subscriber's computer or the Web content server, as described, for example, in “Microsoft 2000 Server: The Microsoft QoS Components”, by Microsoft Corp. (November 1999). Thus, the traffic management software vendor and the MSO need to partner with numerous application developers and Web content providers. Web content providers or subscribers must upgrade the application software on their servers or computers, respectively, to enable “network awareness.” It is no surprise, therefore, that application developers have resisted integrating QoS into their applications. The wide range of applications and fragmentation in several segments of the software market (e.g., computer games) inhibit the deployment of a comprehensive service offering. Additionally, two or more similar applications in the same home or office LAN cannot be reliably identified separately, and thus not enough data flow is supplied to satisfy each user.

Another unsuccessful method uses deep packet inspection hardware to inspect every one of the billions of Internet packets traveling past it for a source and destination IP address, port number, and application type, such as that described by Narad, et al. in U.S. Pat. No. 6,157,955. The packet inspection hardware is generally located regionally at the MSO. In order to determine the application type, and consequently its QoS requirements, the circuits needs to evaluate an entire stream of data between each subscriber and the destination Web content provider. The major advantage of deep packet inspection is that it manages network traffic automatically, and with maximum transparency to both subscribers and content providers. Unfortunately, the packet inspector is highly intrusive in the network and sits directly in the data path making it a possible single point of failure. The unit must be deployed regionally and is subject to local power and space constraints. Hardware upgrades may be difficult and costly. Some applications may be difficult to decipher and the computation requirements may exceed currently available integrated circuit technology. Since the packet inspector must look at every packet as it traverses a decision tree, it is less efficient than other software solutions located closer to the user.

Other previously existing methods, such as those described by Jackowski, et al. in U.S. Pat. No. 6,141,686, merely serve to collect and aggregate application traffic data for retrieval and QoS management by a central policy server, but do not include mechanisms by which user-specific, application-specific customized QoS profiles can be stored and updated on a client machine. Thus, heavy loads are placed on the central policy server, which must process all QoS requests for all client machines, regardless of whether those QoS requests are legitimate. Further, such other previously existing methods are concerned with bandwidth, but not other quality metrics such as jitter or latency. Scheduling QoS for particular applications and users can therefore be problematic with such other methods.

### SUMMARY OF THE INVENTION

In an embodiment of the invention, methods and systems are provided that embed “network awareness” into a system QoS proxy on the subscriber's computing device which dynamically signals the quality of service (including bandwidth, latency and jitter) necessary to ensure that networked applications run well over a shared network, such as a hybrid fiber-coax (HFC) network operated by a cable company. A solution can be rapidly deployed for almost any application or service, and at a lower cost than comparable approaches. It is versatile enough to manage the traffic on almost any network and for any application, since it embeds the core traffic management close to the user and computing device on which the applications are running. This more accurately relays the data flows necessary for each application, and also reduces the computing burden on the central office. Application-specific data flows are restricted exclusively to the application and its associated computing device. For example, one user on the home computing device network can participate in a managed, high-quality videoconference while another can transfer a music file using standard-quality “best-effort”. The solution can be extended to the home in support of CableLabs' CableHome 1.1 Specification CH-SP-CH1.1-I06-041216, December 2004, which is hereby incorporated by reference for all that it teaches without exclusion of any part thereof. The entire process is achieved with relative transparency to the user, so that the traffic management occurs automatically without the subscriber's interaction. The subscriber's only real awareness of this technology may be when the system QoS proxy is upgraded or the premium service tier is billed. Transparency is a benefit because it makes the system easy to use, and it forces applications to use the premium service.

In an embodiment of the invention, a method for establishing a high-quality network connection communications session between a software application running on a subscriber computer and a network service provider is provided, the method comprising capturing a network call from the software application running on the subscriber computer, identifying the software application associated with making the network call, verifying that the software application is authorized to request a high-quality network connection, obtaining a network quality profile corresponding to the software application, and causing to be transmitted to the network service provider a request for a high-quality network connection communications session according to the quality profile, whereby, after the network service provider has processed the request, communications between the software application and the network service provider are of a quality satisfying the requirements of the quality profile.

An embodiment of the invention provides a computer-readable medium including computer-executable instructions facilitating establishing a high-quality network connection communications session between a software application running on a subscriber computer and a network service provider, the computer-executable instructions performing the steps of capturing a network call from the software application running on the subscriber computer, identifying the software application associated with making the network call, verifying that the software application is authorized to request a high-quality network connection, obtaining a network quality profile corresponding to the software application, and causing to be transmitted to the network service provider a request for a high-quality network connection communications session according to the quality profile, whereby, after the network service provider has processed the request, communications between the software application and the network service provider are of a quality satisfying the requirements of the quality profile.

In another embodiment of the invention, a method is provided for establishing a high-quality network connection communications session between a software application running on a subscriber computer and a network service provider, the method comprising, receiving a request for a high-quality network connection on behalf of the subscriber computer, the request caused by a system quality proxy agent residing on either the subscriber computer or a content server contacted by the subscriber computer, the proxy agent having obtained a quality profile for the software application, and the request comprising information about the software application, authenticating the request, obtaining policy information corresponding to the request, and granting a high-quality network connection communications session to the subscriber computer for communications with the application according to the policy information.

Another embodiment of the invention provides a computer-readable medium including computer-executable instructions facilitating establishing a high-quality network connection communications session between a software application running on a subscriber computer and a network service provider, the computer-executable instructions performing the steps of receiving a request for a high-quality network connection on behalf of the subscriber computer, the request caused by a system quality agent residing on either the subscriber computer or a content server contacted by the subscriber computer, the proxy agent having obtained a quality profile for the software application, and the request comprising information about the software application, authenticating the request, obtaining policy information corresponding to the request, and granting a high-quality network connection communications session to the subscriber computer for communications with the application according to the policy information.

In still another embodiment of the invention, a system is provided for managing the quality of a network connection communications session provided to an application running on the computer of a subscriber of a network service provider, the system comprising a database containing information about the subscriber of the network service provider, a policy server storing network quality configuration settings for a variety of conditions, and an application manager, the application manager, in response to a request from a quality proxy agent running on the subscriber's computer, reading from the database and instructing the policy server to establish a network connection communications session with the application running on the subscriber computer at a quality according to an appropriate configuration setting, wherein the request from the quality proxy agent is made according to a quality profile for the application, the profile obtained by the quality proxy agent for the application.

In yet another embodiment of the invention, a method is provided for increasing the revenue of a network service provider, the network service provider providing network service to a plurality of customers, the method comprising, receiving from a requesting entity, on behalf of a computing device associated with a customer in the plurality of customers, a request for a high-quality network connection communications session for an application running on the computing device, wherein the request is in accordance with a quality profile for the application, the profile obtained by the requesting entity, causing network communications for the application to be of a higher quality than ordinary network communications, and billing the customer a fee for services including high-quality network connection communications sessions.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is an exemplary shared network architecture in which quality communications can be managed, in accordance with an embodiment of the invention;

FIG. 2 is an exemplary shared network architecture in which quality communications can be managed with a server-side QoS proxy, in accordance with an embodiment of the invention;

FIG. 3 is a schematic diagram of a computing device including a QoS proxy for requesting quality communications, in accordance with an embodiment of the invention;

FIG. 4 is a flow diagram illustrating a method for requesting quality communications, in accordance with an embodiment of the invention;

FIG. 5 is a schematic diagram of a content server computing device including a QoS proxy for requesting quality communications on behalf of a subscriber, in accordance with an embodiment of the invention;

FIG. 6 is a flow diagram illustrating a method for requesting quality communications on behalf of a subscriber, in accordance with an embodiment of the invention;

FIG. 7 is an exemplary environment in which an application manager can manage quality communications for subscriber computing devices and applications, in accordance with an embodiment of the invention;

FIG. 8 is a flow diagram illustrating a method for granting quality communications for a subscriber, in accordance with an embodiment of the invention;

FIG. 9 illustrate exemplary cases in which quality communications can be managed, in accordance with an embodiment of the invention;

FIG. 10 is an exemplary hierarchical diagram illustrating quality profiles and policies, in accordance with an embodiment of the invention;

FIGS. 11-19 are screenshots illustrating exemplary user interfaces for managing quality profiles and policies, in accordance with an embodiment of the invention;

FIG. 20 is a screenshot illustrating an exemplary user interface with which a subscriber can view and managing quality communication sessions, in accordance with an embodiment of the invention;

FIG. 21 is a flow diagram illustrating a method for granting quality communications for a subscriber using a URL rather than a static IP address, in accordance with an embodiment of the invention;

FIG. 22 is a diagram illustrating a protocol for initiating, establishing and ending a quality communications session, in accordance with an embodiment of the invention;

FIG. 23 is a diagram illustrating a protocol for initiating a QoS proxy and receiving configuration parameters, in accordance with an embodiment of the invention;

FIG. 24 is a diagram illustrating a protocol for establishing and ending a quality communications session, in accordance with an embodiment of the invention; and

FIG. 25 is a diagram illustrating a protocol for managing errors in establishing a quality communications session, in accordance with an embodiment of the invention.

### DETAILED DESCRIPTION OF THE INVENTION

The problem of managing quality of service (QoS) in shared networks is a growing problem facing the broadband industry. For example, in existing cable networks, there is a bottleneck for providing necessary QoS for VoIP in the upstream direction. Cable networks use a time-division-multiplexing (TDM) based protocol to assign transmission opportunities (known as mini-slots in cable modem terminology) to the cable modems. To ensure that QoS (jitter, latency, and bandwidth) meets the VoIP requirements for the duration of the call, the cable modem termination system (CMTS) (e.g., centrally located cable router) reserves the resources (mini-slots in the upstream and bandwidth in the downstream) for the call when it receives a QoS request from a session initiated protocol (SIP)-based softswitch (packet switching platform). When the call is finished it releases the resources.

Cable networks are usually engineered for 2000 users to share a ˜36 Mbps downstream channel and for 500 users to be sharing a ˜6-10 Mbps upstream channel. In cable networks there are usually 4-6 upstream channels per downstream channel.

The first problem in deploying QoS for VoIP is managing the QoS. The industry's recent standard, PacketCable Multimedia (PCMM), specifies the protocol for requesting and granting the QoS but does not specify how to manage the QoS. The PCMM standard is defined in CableLabs' “PacketCable Multimedia Specification PKT-SP-MM-102-040930”, September 2004, and “PacketCable Multimedia Architecture Framework Technical Report PKT-TR-MM-ARCH-V01-030627”, June 2003, which are hereby incorporated by reference for all that they teach without exclusion of any part thereof. Managing QoS requires more than just granting QoS because the QoS in the network is a finite resource. As QoS is granted for VoIP services, the best-effort data services will be affected. Therefore QoS management systems take this into account when making a decision on whether to grant the request or not. This is commonly referred to as “admission control.”

The rules for when to grant QoS are binary when there is only one QoS service is at issue: either there is QoS (e.g., for VoIP), or there is “best-effort” data (no QoS). In the multiple QoS service scenario, the decision becomes how to best divide up the network resources available for QoS-based services. Each QoS service generally has its own unique QoS requirements (bandwidth, jitter, and latency) and value to the MSO. The value to the MSO is a function of the revenue stream less the costs to provide the service. The cost of the QoS is a function of the bandwidth, jitter, and latency required in each direction. The revenue stream is a function of the premium the MSO can charge for the service and the customer satisfaction.

Embodiments of the present invention effectively manage the QoS in a shared network on a per-application, per-user basis. This allows an MSO to apply business rules that take into account the value and cost of the QoS for each application and the subscriber requesting to use the service.

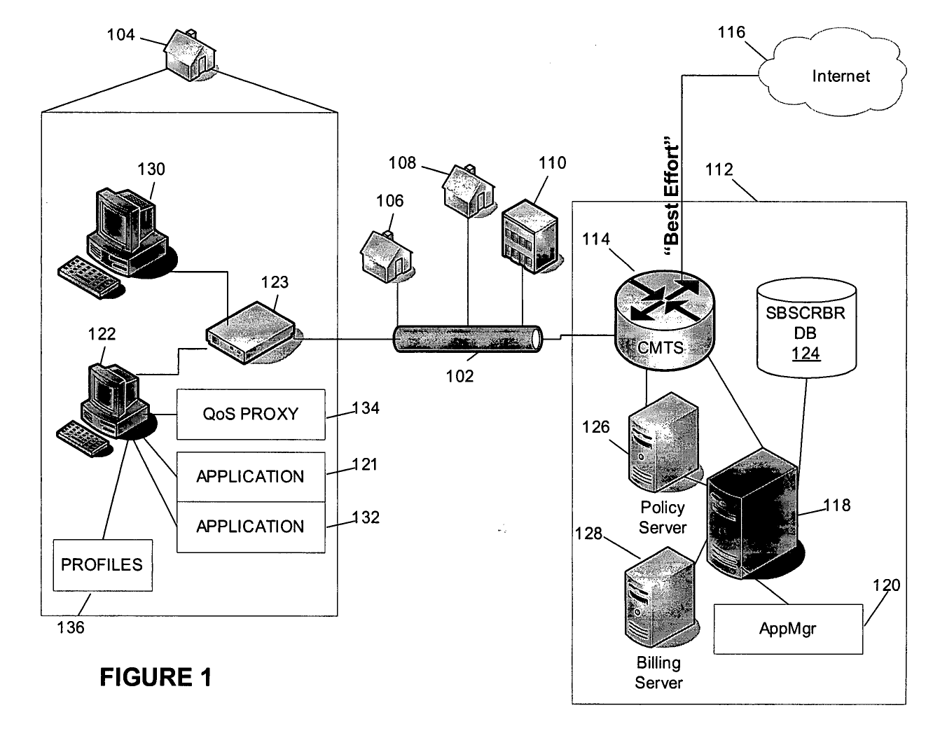

An exemplary architecture for managing communications quality on a per user, per application basis is shown in FIG. 1, in accordance with an embodiment of the invention. A shared network 102 connects various locations, such as homes 104, 106, 108 and businesses 110 to a network services provider, or “Multiple System Operator” (MSO) 112. The shared network 102 is preferably a hybrid fiber coax (HFC), preferably operating according to the DOCSIS protocol and PacketCable MultiMedia (PCMM) specification. Alternatively, the shared network 102 operates according to the DOCSIS protocol over satellite or WIMAX. The shared network 102 connects to the MSO 112 via a cable modem termination system (CMTS) 114, and the MSO 112 in turn connects to the Internet 116. Although only a single CMTS 114 is shown in FIG. 1, the MSO 112 preferably connects to the shared network 102 through a plurality of CMTSes, with each CMTS serving several thousand users. Communications between the MSO 112 and the Internet 116 are generally performed on a “best-effort” basis, where packets are not given priority over one another and are processed in a first-come, first-served basis. The MSO 112 hosts a server 118 that runs an application manager program 120. The application manager 120 receives requests for high-quality communications sessions with applications running on computing devices of subscribers. For example, at the home 104, an application 121 running on one of the home's 104 locally networked computing devices 122 causes a request for high-quality communications. The request is forwarded through the home's 104 cable modem/router 123, over the shared network 102, and received by the application manager 120 running on the MSO server 118. The application manager 120 processes the request using a subscriber database 124 and a policy server 126. The subscriber database 124 preferably contains information regarding the person responsible for the home's 104 subscription to the cable modem service, and is used for authorization purposes. The policy server 126 serves as an intermediary between the application manager 120 and the CMTS 114, monitoring resources and distributing policy to the CMTS 114 associated with the home's 104 cable modem/router 123. The application manager 120 uses additional quality information regarding the quality level of service to be given based on types of applications, subscription levels, and other criteria. The MSO server 118 further is preferably associated with a billing server 128, which is responsible for ensuring that the high-quality communications session is billed to the subscriber according to the subscriber's subscription terms.

Once a request is received and processed by the MSO server 118, a high-quality communications session is established between the CMTS 114 and the application running on the subscriber's computing device. In the example above, application 121 is given a high-quality communications session with the MSO 112, so communications between application 121 and the MSO's 112 CMTS 114 are given higher priority (i.e., to ensure that bandwidth, latency and jitter requirements are satisfied) than communications from other end users 106, 108, 110 sharing the shared network 102. Additionally, application 121 is given higher priority than other computing devices 130 on the same local network as the application's 121 computing device 122 (e.g., sharing the same cable modem/router 123). Application 121 is even given higher priority than other applications 132 running on the same computing device 122.

Requests for high-quality communications can be made in several ways. One technique, as used in an embodiment of the invention, includes a system QoS proxy 134 running preferably as software on the subscriber's computing device 122. The QoS proxy 134, previously installed on the subscriber's computing device 122, registers with the application manager 120 upon startup. During this registration, application-specific QoS profiles 136 are authorized and/or modified and/or downloaded to the computing device 122 and preferably stored locally on the computing device 122, for example, on a hard drive or in a local system memory store within or attached to the computing device 122. In some embodiments of the invention the QoS profiles 136 are further updated at periodic intervals by the application manager 120. For example, the MSO 112 can offer a premium “gaming tier” subscription to allow high-quality communications sessions when subscribers are playing popular games; the MSO 112 can send game-specific QoS profile updates to the computing device 122 to be stored with the other QoS profiles 136. The QoS proxy 134 intercepts network calls from applications running on the computing device 122 and classifies information about the source, destination, port number and application making the network call. The QoS proxy 134 determines whether and what level of QoS is required for the calling applications or services by comparing the classified information to the quality profiles 136, and then sends a request to the application manager 120 at the MSO 112. The application manager 120 authenticates the subscriber, the application, and the appropriate tier of service. The request is authorized based upon business policies established by the MSO 112. If authorized, a message is sent to the policy server 126 for distribution to the CMTS 114.

As an example of the use of such a system QoS proxy, consider a subscriber running an online game that requires low latency. If the subscriber has subscribed to a premium ‘gaming tier’ service of the MSO, then a high-quality (in this case, low-latency) communications session is made available for the duration of the game.

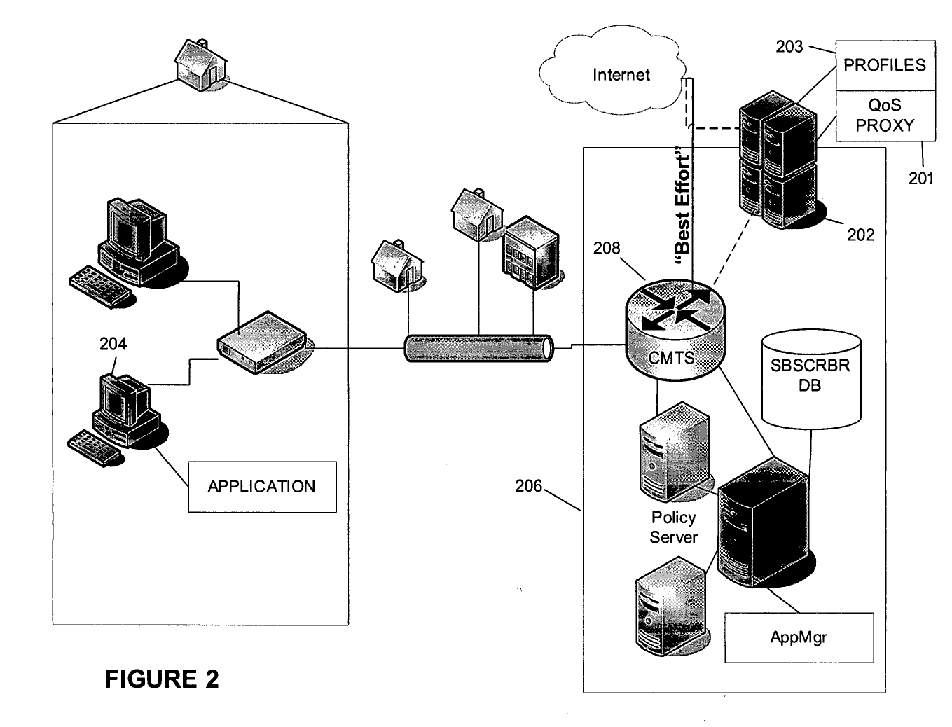

An additional technique, as used in an embodiment of the invention, is shown in FIG. 2. To use this technique, a system QoS proxy 201 is included at a web content server 202. The server 202 retrieves and/or updates quality profiles 203 from the MSO 204 upon startup and/or at periodic intervals. When a subscriber's computing device 204 requests high-quality demanding content from the content server 202, the system QoS proxy 201 uses the quality profiles 203 to identify the calling application and other information, and makes a request on behalf of the subscriber for a high-quality connection between the computing device 204 and the MSO's 206 CMTS 208 i.e., a high-quality “upstream” connection from the subscriber's computing device 204 to the CMTS 208, and a high-quality “downstream” connection from the CMTS 208 to the subscriber's computing device 206. The MSO 204 processes the request and provides high-quality communications to the particular application on the subscriber's computing device 204 in a manner similar to that described above. By using this technique, the MSO 206 can allow subscribers, for example, to automatically obtain high-quality communications when transferring large files or receive streaming content from the content server 202. Furthermore, no application server integration is required with the MSO 206, since the server 202 automatically signals the MSO's 206 application manager that content-specific QoS is required with the authorized subscriber's computing device 204 over the shared network. Additional details on this approach appear below.

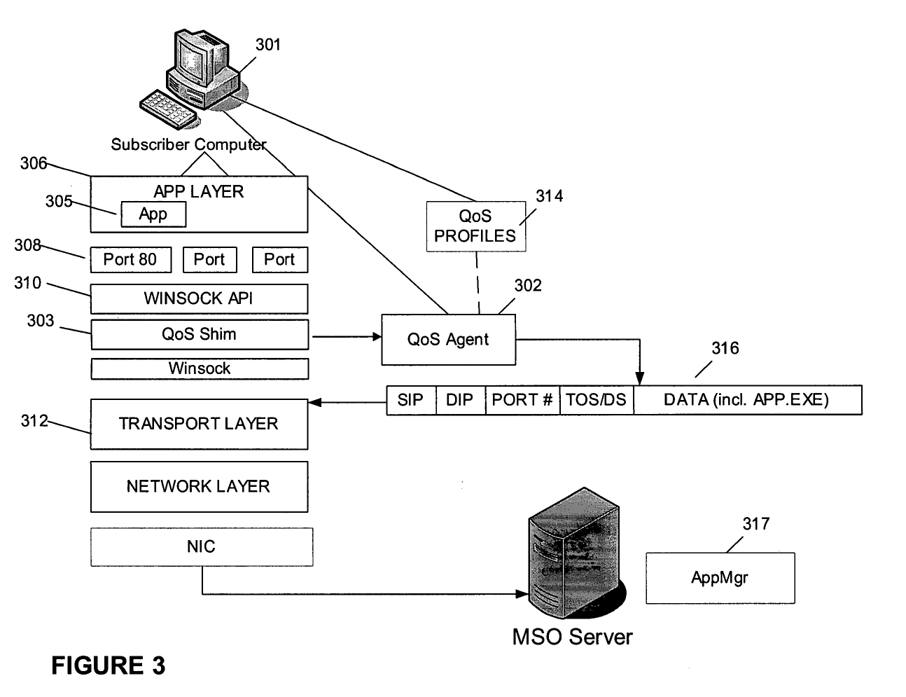

Turning attention to FIG. 3, the system QoS proxy is described in more detail in the context of a method for establishing a high-quality communications session via a client-initiated request, in accordance with an embodiment of the invention. The QoS proxy runs on the subscriber's computing device 301 or specialized networked device such as a personal video recorder or computer gaming console to perform core traffic management. The QoS proxy comprises two parts: a QoS agent 302; and a QoS “shim” 303. Although the QoS agent 302 and QoS shim 303 are described as separate internal components of the QoS proxy, the term “agent” or “quality agent” is commonly used to refer to the functionality of the entire QoS proxy, including both QoS agent 302 and QoS shim 303. Applications 305 run in the application layer 306 of the computing device 301 and make network calls through software ports 308. In the example of FIG. 3, the applications make network calls according to a Winsock Applications Programming Interface (API) 310 of the Microsoft Windows operating system. The invention is not limited to operation on the Microsoft Windows operating system, however; any number of operating systems are compatible with the invention, including Unix and the Apple Macintosh OS X operating systems, as described more fully below. The system QoS shim 303 sits between the Winsock API 310 and the transport layer 312 of the computing device 301. The QoS shim 303 intercepts and monitors network events on the subscriber's computing device 301, classifying the events made by applications 305 based on source and destination IP addresses, port number, protocol (TCP or UDP), application making the network call and event type (e.g., Connection Open, Connection Close, UDP Initial Packet Send, Application Terminated). The QoS shim 303 passes this information to the QoS agent 302.

The QoS agent 302 typically runs as a background process and matches the calling application against a list of authorized applications and QoS profiles 314. In an embodiment of the invention, the QoS agent 302 looks at process information associated with the application making the API call. From the process information, the QoS agent 302 obtains the command line string that was used to launch the application. In addition, the QoS agent 302 can obtain meta-information associated with the application. The QoS agent 302 uses the command line or meta information and does a pattern match (for example, using regular expressions) to see if the application is known by the QoS agent 302. If so, the QoS agent 302 checks if there is a QoS policy for the application. The list of authorized applications and QoS profiles 314 are preferably stored locally on the subscriber's computing device 301. If the calling application is authorized locally, the QoS agent 302 generates a message 316 and sends it to a remote application manager 317 for subscriber authentication and authorization and establishment of a high-quality communications session according to the quality profile 314. In this manner, the QoS agent 302 automatically signals the precise QoS requirements to the remote application manager 317 for admission control. The message 316 includes the data flow parameters specified by the PCMM specification. In one embodiment, the message 316 is a SIP/DIP message. Alternatively, the message 316 is an XML message over the SOAP protocol. In some embodiments, the message 316 includes instructions to “color” packet bits to mark a change in packet priorities for networks such as private SONET networks and Local Area Networks (LANs) through the use of TypeOfService/DiffServ (TOS/DS). The QoS agent 302 also preferably makes a call to a local QoS traffic control API to instruct the TCP/IP stack to color bits for this flow. When QoS is no longer required, the premium service is terminated. The QoS shim 303 either intercepts an API call by the application to close the connection, or is notified through a call-back from the operating system that the application has terminated. The QoS agent 302 sends a request to the application manager 317 to terminate the high-quality communications session, and communications resume at their default levels.

In this manner, the QoS agent 302 and shim 303 can rapidly manage the traffic requirements for virtually any application on any network without involving the application developer, and without deploying hardware. Some applications are thus made “network aware” that cannot be enabled by other methods since these applications either lack the inherent QoS signaling capability, or their application signatures cannot be easily inspected. For example, the QoS agent 302 can uniquely enable an application or family of applications for transfers for computer data or digital photo back-ups. The QoS agent can extend PCMM by enabling a virtual private network (VPN), which re-creates being on the corporate environment but in a telecommuter's home. Since the core intelligence of the system sits near the application running on the user's computing device 301, the system is capable of efficiently providing an optimal amount of data flow to the application and computing device 301.

In some embodiments of the invention, the system QoS agent 302 and shim 303 are automatically installed by or for the subscriber, for example, as part of an initial setup with the subscriber's network service provider. Alternatively, the subscriber installs the QoS agent 302 and shim 303. The network service provider can further update the quality profiles 314 on the subscriber's computing device 301 as necessary, according to, for example, applications included in subscription tiers subscribed to by the subscriber, or new, recently-subscribed-to tiers. The subscriber's quality profiles 314 are kept current through the use of a state update messaging protocol between the QoS agent 302 and the application manager 317.

In an alternative embodiment, the QoS shim 303 sits below the transport layer 312 as a driver, and supplies a new TCP/IP stack for network communications. Such an embodiment is useful if the presence of anti-spyware software is present on the subscriber's computing device 301.

As noted above, the subscriber's computing device 301 can run any of a number of operating systems for which a system QoS agent 302 can be used to automatically request high-quality network communications. In the Microsoft Windows operating system, as illustrated above, the QoS shim 303 is a Layered Socket Provider (LSP) shim sitting between the Winsock 2 API and the transport layer. The LSP shim is a custom provider that is registered with Winsock, so that all application socket calls are dispatched to the custom provider. In addition to intercepting network service calls and creating QoS requests for the central application manager, it can also call the Windows traffic controller to set the DiffServ bits. The traffic controller is very flexible and can set the TOS bits or various configurations

In the Linux operating system, system calls go through an array, sys_call_table[] which directs network requests. The array stores the pointers which direct the calls. The QoS agent 302 is invoked by a pointer re-directing the applicable OS call to the QoS agent 302, which makes the QoS request to the application manager. In more detail, to intercept a system call, original pointers are overwritten with pointers to new functions. The original pointers are saved, and later written back at cleanup. Linux architecture provides means via modules (dynamically loadable/unloadable components) to extend the kernel functionality. The Linux module can be dynamically loaded at any time, or may included in a configuration file, which contains a list of modules to load when system boots. Linux further has the native capability to mark/color the DS/TOS bits.

In a similar manner to the Linux case, the QoS agent 302 can be made to operate in a computing device running other variations of the Unix operating system, including BSD Unix, upon which the Macintosh OS X operating system is based. For the Sun Solaris operating system, all processes make system calls to the OS. The QoS agent 302 sits at the /proc layer, which monitors and intercepts the applicable networking calls and makes the QoS request to the application manager. By monitoring /proc/pid, once can attach to a particular process, and specified system calls can be captured at entry and exit. The invention is not limited to the Microsoft Windows, Linux and Unix operating systems, however; the invention can generally be embodied with any computing device operating system that allows the intercepting and monitoring of network calls.

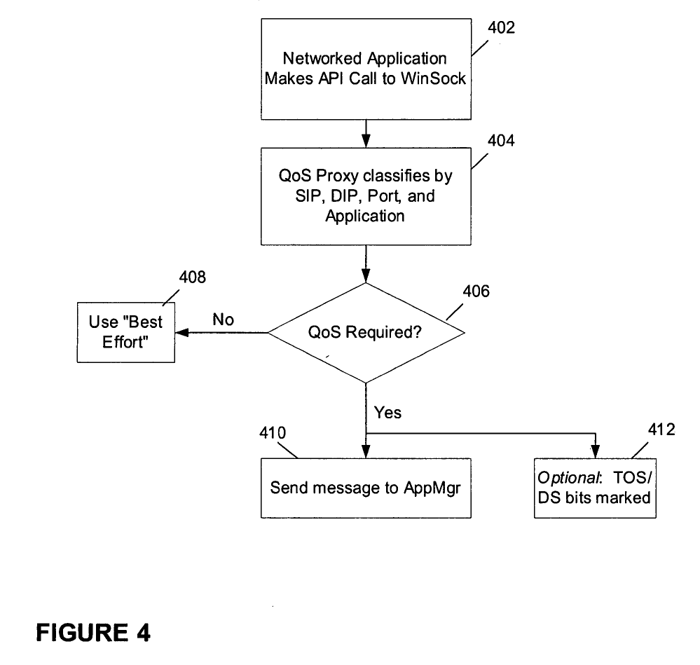

In FIG. 4, a method is shown for use in a subscriber's computing device to request high-quality communications over a shared network, in accordance with an embodiment of the invention. A networked application makes a network call by invoking an API function call to WinSock in step 402. The API call is intercepted by the system QoS proxy, which classifies call information including the source and destination IP addresses, port and calling application, in step 404. At step 406, the QoS proxy determines whether high-quality communications service is required by, for example, comparing the classified information with quality profiles stored on the subscriber's computing device. If no high-quality communications is required, communications proceed as normal using a “best-effort” approach at step 408. Otherwise, a message containing a request for high-quality communications is sent over the shared network to a central application manager at step 410. Additionally, at step 412 the QoS proxy can mark (i.e., “color”) particular bits, such as the TOS/DS bits, of the communications packets for the calling application to indicate a certain priority level for these packets, which can be honored by private or other networks.

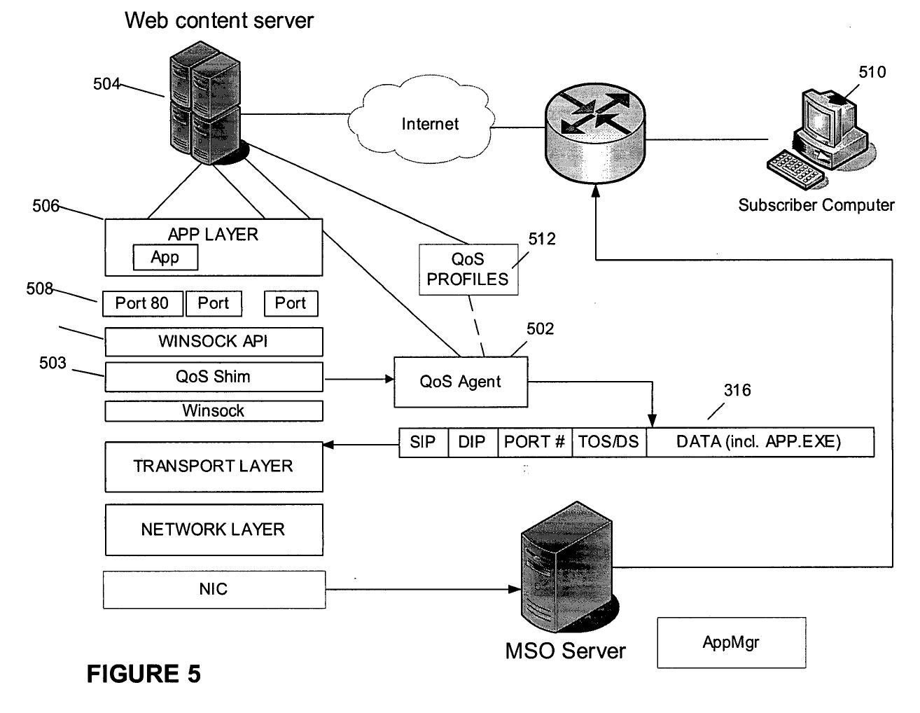

Turning attention to FIG. 5, the system QoS proxy is described in more detail in the context of a method for establishing a high-quality communications session via a web server-initiated request, in accordance with an embodiment of the invention. In this context, the core traffic management is embedded in a system QoS proxy, comprising a QoS agent 502 and a QoS shim 503 residing on the web content server 504. Applications (e.g., a network game server) run in the application layer 506 of the server 504 and make network calls through software ports 508. The QoS agent 502 and shim 503 operate in a similar manner to the client-side QoS agent and shim described with reference to FIG. 3, with a few differences due to the fact that the QoS agent 502 requests high-quality communications not for its host web server 504, but rather on behalf of a subscriber's computing device 510 that has requested content from the server 504. Thus, when the QoS proxy classifies network calls based on source and destination IP addresses, it understands that the “source” is actually the subscriber's computing device 510, while the “destination” is actually the web server 504. Furthermore, the web server 504 compares the classified information against a list of authorized subscribers (rather than authorized applications) and quality profiles 512.

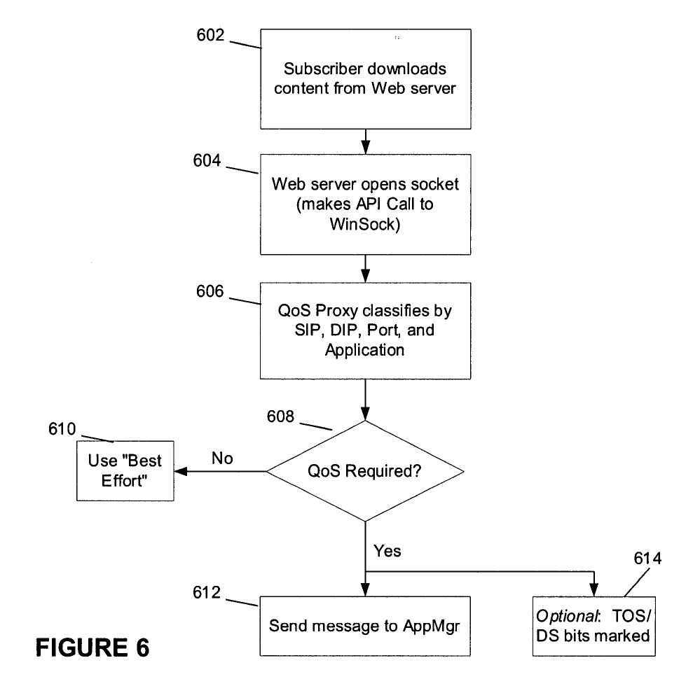

A method for using a content server-side QoS proxy to request high-quality communications on behalf of a subscriber's computing device is shown in FIG. 6, in accordance with an embodiment of the invention. An application running on a subscriber's computing device requests content from a web content server at step 602. The content server opens a socket at step 604 by, for example, making an API call to WinSock. The call is intercepted by the QoS proxy, which classifies call information including the source and destination IP addresses, port and calling application, at step 606. At step 608, the QoS proxy determines whether high-quality communications service is required by, for example, comparing the classified information with quality profiles stored on the web content server. If no high-quality communications is required, communications proceed as normal using a “best-effort” approach at step 610. Otherwise, a message containing a request for high-quality communications for the application running on the subscriber's computing device is sent over the shared network to a central application manager at step 612. Additionally, at step 614 the QoS agent can mark (i.e., “color”) particular bits, such as the TOS/DS bits, of the communications packets for the calling application to indicate a certain priority level for these packets, which can be honored by private or other networks.

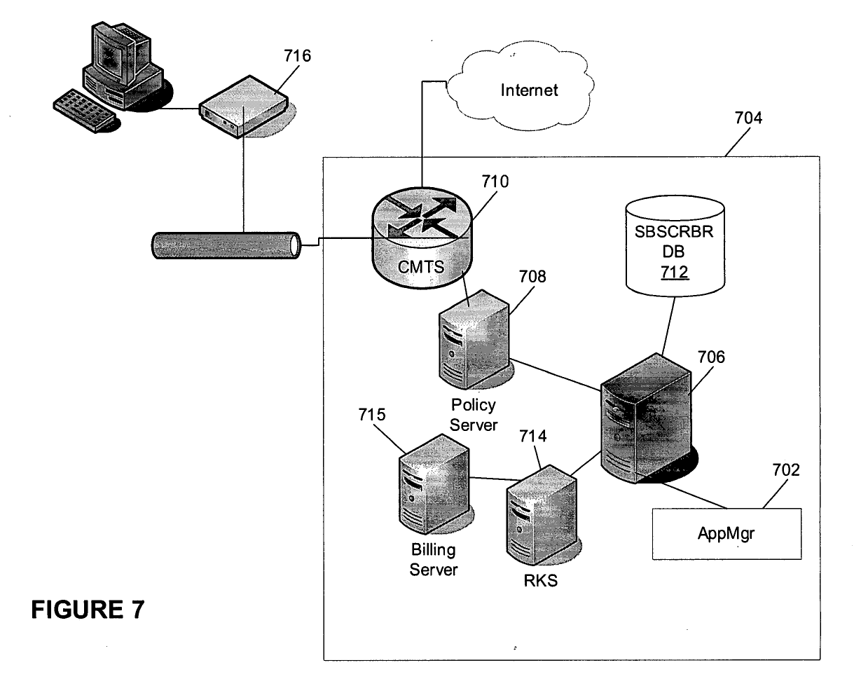

Turning to FIG. 7, an application manager (AppMgr) 702 is described for managing high-quality communications between an MSO 704 and an application running on a subscriber's computing device, as used in an embodiment of the invention. The AppMgr 702 preferably operates as part of the MSO's 704 provisioning system, providing dynamic provisioning of services that use QoS for subscribers. The AppMgr 702 is integrated into the MSO's 704 back office support system and can use previously existing order entry systems and subscriber databases. Although the AppMgr 702 runs on a server 706, there is no requirement that the server 706 operate any particular operating system; the AppMgr 702 is platform independent, and can run on any of a number of popular web server operating systems, including, but not limited to: Microsoft Windows, Apache, Unix, Linux and Solaris. The AppMgr 702 communicates with a policy server 708 that serves as the single point of entry between the AppMgr 702 and the CMTS 710 for quality of service requests. When a request for QoS is received by the AppMgr 702, it authenticates the calling subscriber and application via a subscriber database 712, and authorizes the QoS data flow and submits a request for QoS to the policy server 708. The policy server 708 applies stored policy rules, pertaining generally to resource availability at a particular CMTS 710 for the subscriber, and decides whether to forward the request to the CMTS 710 for final admission.

In some embodiments, the server 706 hosting the AppMgr 702 is the same as the policy server 708, and are not separate servers. In such embodiments, the AppMgr 702 can perform policy functions typically performed by a policy server, so that no policy server 708 need be present. The AppMgr 702 communicates directly with the CMTS 710 to manage resource availability and/or make admission decisions. Incorporating the functionality of the policy server 708 into the AppMgr 702 is particularly beneficial for a small MSO 704 employing one or a handful of CMTSes, since the MSO 704 is alleviated of the need for specialized policy server. In some embodiments, a discovery mechanism is included in the AppMgr 702 to determine the appropriate CMTS for a subscriber.

In accordance with the PCMM specification, some embodiments of the invention use a Record Keeping Server (RKS) 714 as the interface and mediator between network activity and the MSO's 704 billing system 715. The RKS 714 creates billing records that it forwards to the billing system 715. A billing record is generated whenever the RKS 714 can match two PacketCable Event records from the policy server 708 and the CMTS 710. Whenever the policy server 708 receives a “Gate-Set-Ack” it generates an event message to the RKS 714. Likewise, the CMTS 710 generates a corresponding event message to the RKS 714 when it actually creates the gate. When the RKS 714 gets both event messages it accurately generates a billing event. The same sequence of events occurs when the gate is deleted. The MSO 704 can bill subscribers according to a number of criteria and subscription plans. For example, a subscriber can be billed per transaction, time reserved, time of day, day of the week, quality of the connection reserved (amount of bandwidth, restrictions on latency and jitter), amount of bits transferred, and other criteria. The MSO 704 alternatively or in addition can charge for an unlimited use of a high-quality connection based on combinations of these criteria. Numerous other possible billing alternatives are available, any number of which can be offered by the MSO 704.

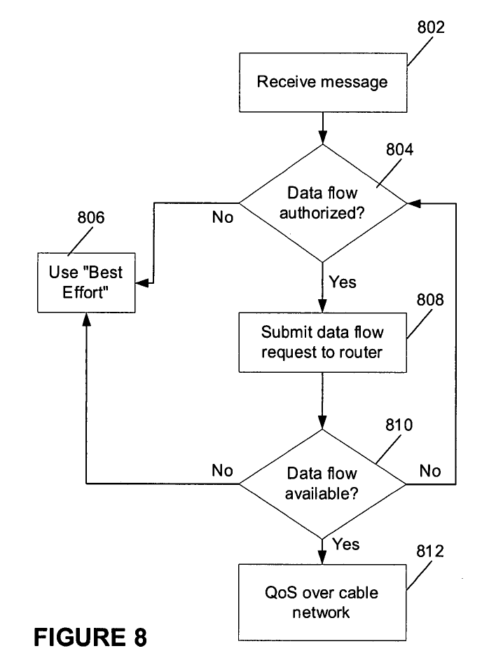

A general method for use by an application manager to manage QoS, as used in an embodiment of the invention, is shown in FIG. 8. The AppMgr receives a message including a request for QoS at step 802. The AppMgr processes the request to determine whether the subscriber and calling application are authorized for QoS at step 804. If not, the request is denied and the requesting application communicates via best-effort at step 806. Otherwise, the AppMgr forwards the request, preferably via a policy server, to the CMTS or router at step 808. The router then determines if the requested data flow is available at step 810. If so, then a communications session is established at the requested QoS over the shared network at step 812. Otherwise, the request is resubmitted to the AppMgr at step 802, or the session is limited to best-effort at step 806.

Returning to FIG. 7, the AppMgr 702 considers a variety of constraints in managing QoS for the shared network 712, including, but not limited to: number of available gates in each direction; available channel bandwidth; gate switching time; number of active sessions by the subscriber; and time of day. Some embodiments further consider the rate of sending information to the record keeping system (RKS) 714.

By way of background, DOCSIS permits 65535 gates per CMTS 710 where a gate is logical entity representing a unidirectional data flow with QoS. For example, a voice call requires two gates: one upstream and one downstream. A video call requires 4 gates: two upstream (audio+video) and two downstream (audio+video). A cable modem 716 can theoretically support up to 2ˆ14 gates in the upstream direction. In practice a cable modem 716 supports approximately 16 gates in the upstream (65,535 gates/2 (upstream+downstream)/2000 modems per CMTS). In actuality, the number is even less due to the fact that a large number current cable modems use a version of a Broadcom DOCSIS chipset that only supports four gates. One service flow must be used as the primary service flow (default) and thus there are 3 that are available to be used by the QoS management system. This limitation of three upstream gates limits the number of simultaneous VoIP phone calls that can handled by a single cable modem to three, or to one voice call and one video call.

The AppMgr 702 therefore detects (dynamically or otherwise) and takes into account the number of gates a cable modem can support and minimizes the number of gates required to support QoS services. In one embodiment, the AppMgr 702 attempts to dynamically combine similar gate requests from the same cable modem 716. Additionally, the AppMgr 702 uses logic in requesting QoS, and is cognizant of the underlying QoS mechanisms the CMTS 710 employs in honoring the QoS request.

By way of more background, QoS for DOCSIS networks is described more fully by Sunkad in “Quality-of-Service: A DOCSIS PacketCable Perspective—Part II”, (http://www.cablelabs.com/news/newsletter/SPECS/MayJune2000/news.pgs/story5.html) which is hereby incorporated by reference for all that it teaches without exclusion of any part thereof. QoS is provided at layer 2 or the media-access-control (MAC). The MAC protocols in DOCSIS in the upstream and downstream are different, but in both cases, the DOCSIS network is a shared media. In the downstream, MAC appears very much like Ethernet since it is a one-to-many (CMTS to cable modems). In the upstream, DOCSIS uses a time-division-multiplexing scheme to assign transmission mini-slots. The assignment of the mini-slots is dependent upon the scheduling routine for the service type. DOCSIS uses four types of scheduling routines: best-effort, unsolicited grant, real-time polling, and non-real-time polling.

For best-effort type services, the cable modem 716 sends a request to the CMTS 710 for a future transmission opportunity. This request is sent in what is referred to as the “contention” region of a TDM frame. Transmissions in the contention region are susceptible to transmission collisions from other cable modems making similar requests. When the CMTS 710 receives the request, it acknowledges it to the modem 716 and schedules the request at some point in the future. Best-effort type transmissions on busy networks are thus susceptible to wide variances in the time between scheduled transmission requests due to having to contend with other modems for these opportunities. As a result, the inter-packet latency varies, which is referred to as jitter.

In contrast to best-effort, Unsolicited Grant Service (UGS) addresses the problems associated with best-effort for services that have tight tolerances on jitter and latency such as VoIP. UGS works by reserving a set of mini-slots in advance for the cable modem 716. The CMTS 710 then grants transmission opportunities to the cable modem 716 on a regular basis whether the cable modem has something to send or not. UGS provides a constant bit rate service (CBR).

In contrast to best-effort and UGS, real-time polling and non-real-time scheduling use a polling scheme. When a cable modem 716 requests a non or real-time polling service, the modem 716 includes a polling interval. The CMTS 710 then polls the modem 716 at this regular interval asking if it has anything to send. If the modem 716 has something to send, then the CMTS 710 schedules a transmission opportunity for the modem 716 in the near future. Polled scheduling is a compromise between a UGS and best-effort. Polling eliminates the possibility of collisions between modems requesting transmission opportunities while at the same time not wasting bandwidth (mini-slots) when modems do not have anything to send.

QoS in DOCSIS networks is managed at the MAC layer by the CMTS 710. When a QoS request is accepted by the CMTS 710 it sets a gate (i.e., a logical entity within the CMTS 710). Every gate has associated with it a set of QoS parameters (bandwidth, jitter, latency, packet classifier, and service type) that define the service flow. For downstream data the traffic, classification and policing is done on the CMTS 710 before the traffic is sent across the shared network 712 to the modem 716. The CMTS 710 classifies the data and puts the data on the respective service flow's (SFID) queue, and then uses a queuing algorithm such as weighted-fair-queuing (WFQ), classless-fair-queuing, or priority-based-queuing.

For the upstream, the CMTS 710 issues a management message to the cable modem 716 instructing it to create a SFID classifier and queue for the packets to correspond to the gate. Additionally, the CMTS 710 inserts the SFID into its upstream mini-slot scheduler to schedule transmission opportunities for the modem 716. Thus for the upstream the classification and policing is done at the cable modem 716 and the scheduling (i.e., traffic shaping) is done by the CMTS 710.

In some embodiments of the invention, the AppMgr 702 optimizes the use of gates by the cable modem 716 and CMTS 710. For example, in one exemplary case a gate can be created for downstream and one for upstream, where the upstream gate is configured to use real-time polling scheduling and the downstream gate is configured with a guaranteed minimum bandwidth in order to improve response time for an interactive session. Sufficient bandwidth is allocated to ensure there is no congestion between the two endpoints. In a second exemplary case, a bi-directional email session can be established with a gate for each direction. If the two cases are simultaneously active, the AppMgr 702 modifies an existing gate to be the union of the two service flows. This is achieved, for example, by increasing the bandwidth in each direction to represent the sum of the bandwidth for both services flows, while modifying the latency to meet the smaller of the two.

In a third exemplary case, a peer-to-peer session, such as a two-player game or videoconference, can be established with two gates for each peer's cable modem 716. In such a case, the AppMgr 702 preferably matches the gate requirements for the upstream and downstream flows in each direction. For example, if the upstream QoS is:
Bandwidth=1 Mbps
Latency<=100 mSec
   Jitter<=10 mSec
Service Type=Real-time polling
   then the AppMgr should make sure that the downstream QoS bandwidth to the second peer is:
Bandwidth=1 Mbps
Latency<=100 mSec
   in order to minimize wasted bandwidth.

In accordance with the PCMM specification, each gate has associated with it one or more packet classifiers. An eight-tuple classifier, as used in some embodiments of the invention, contains the following fields: Protocol, Source IP address, Source port, Destination IP address, Destination port, Priority, and DSCP/TOS mask. Protocol is an IP protocol field (RFC 1700) value (IP, ICMP, etc.), where a value of 256 matches any IP protocol, and 257 matches both TCP and UDP. The source IP and destination IP addresses are the addresses seen by the CMTS as the respective originator and termination point of the IP flow. The source and destination ports are UDP or TCP ports. Priority indicates a search order for which to apply the classifiers in case of a classifier overlap (i.e., highest priority is applied first). Classifiers may include wild-card fields (indicated by zero fields). Downstream classification is performed by the CMTS 710, while upstream classification is performed by the cable modem 716. If a packet does not match any classifier, then the packet is forwarded to the primary or default service flow, which is normally best-effort.

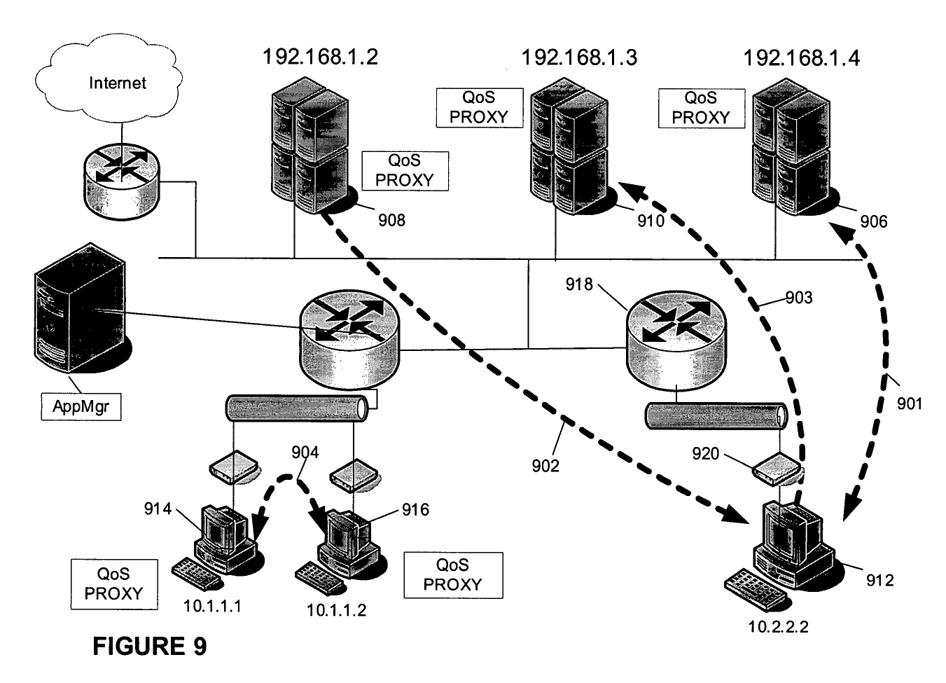

In some embodiments of the invention, the AppMgr 702 uses classifiers to manage QoS for subscribers and applications. Classifiers are associated with service-spec objects of subscriber policies stored in the subscriber database 712. A service-spec is a three-tuple binding of: application group, traffic profile (i.e., QoS parameters for the flow), and packet classifiers. By using service-specs, broadband service is defined or created by associating a group of applications that have similar QoS requirements to a common end-point for the traffic flow. Thus, when the system QoS proxy is installed on a subscriber computing device, the classifier maps to one or more host or network destinations that are within the MSO's 704 managed network. For the case when the system QoS proxy is installed on a web content server, the classifier is used to determine if the connecting client is from the MSO's 704 network. An example set of classifiers is given in Table 1, corresponding to the examples illustrated in FIG. 9.

TABLE 1

| | Direc- | Proto- | | Source | | Dest | Prior- | DSCP/ |
|---|---|---|---|---|---|---|---|---|
| Example | tion | col | Source IP | Port | Dest IP | Port | ity | TOS |
| Case 901 | Up | TCP | 10.2.2.2 | X | 192.168.1.4 | 25 - | x | x |
| Upstream - | | | | | | SMTP | | |
| E-mail | | | | | | | | |
| Case 901 | Dn | TCP | 192.168.1.4 | POP3 | 10.2.2.2 | X | X | x |
| Downstream | | | | | | | | |
| E-mail | | | | | | | | |
| Case 902 - | Dn | TCP | 192.168.1.2 | X | 10.2.2.2 | X | X | x |
| Streaming | | | | | | | | |
| Media | | | | | | | | |
| Case 903 - | Up | TCP | 10.2.2.2 | X | 192.168.1.3 | 80 | X | x |
| HTTP | | | | | | | | |
| Upload to | | | | | | | | |
| Website | | | | | | | | |
| Case 904 - | Up | UDP | 10.1.1.1 | ? | 10.1.1.2 | ? | X | X |
| Peer to Peer | | | | | | | | |
| from PC1 to | | | | | | | | |
| PC2 | | | | | | | | |

In FIG. 9, several exemplary cases 901, 902, 903 and 904 are shown. In cases 901, 902 and 903, web content servers 906, 908 and 910 host system QoS proxies, such as those described with reference to FIGS. 2, 5 and 6, for requesting QoS on behalf of the subscriber computing device 912. In case 901, a bidirectional email session is established between a web content server 906 and the subscriber computing device 912 using two gates. In case 902, a gate is created for a downstream session for streaming video from web content server 908. In case 903, a gate is created for an upstream session for uploading content to a website on web content server 910. In case 904, a bi-directional session is established between two subscriber computing devices 914 and 916 for peer-to-peer communications. Each of subscriber computing devices 914 and 916 contain a system QoS proxy for requesting QoS, such as one described above with reference to FIGS. 1, 3 and 4.

In the examples of FIG. 9, there is potential for several overlapping classifiers. A packet classifier is considered a match if

((packet protocol==classifier protocol)|(classifier protocol==0))

AND ((packet source IP==classifier source IP)|(classifier source IP==0))

AND (packet source port==classifier source port)|(classifier source port==0)).

As can be seen in Table 1, the potential for overlapping packet classifier exists for the downstream cases of case 901 and 902. If a classifier of (source=TCP//192.168.1.0:0 and destination=TCP//10.2.2.2:0) was used to indicate any TCP traffic from the 192.168.1.0 subnet to the 10.2.2.2 both service flows, then it would be ambiguous as to which service flow the CMTS 918 should classify the packets. The same would be true if the reverse classifier was used for the upstream. The cable modem 920 would not be able to distinguish between the two service flows.

As the simple example illustrates, the process of constructing classifiers can become complicated when trying to define a set of classifiers for a large set of service specifications. This can get further complicated due to the fact that many applications use dynamic port assignments and therefore cannot be easily characterized by their well-known ports. Therefore, the AppMgr 922 in some embodiments of the invention tries to ensure that the packet classifiers do not overlap, and that when they do that the MSO is informed so that it may correct the problem or provide priorities to the overlapping classifiers.

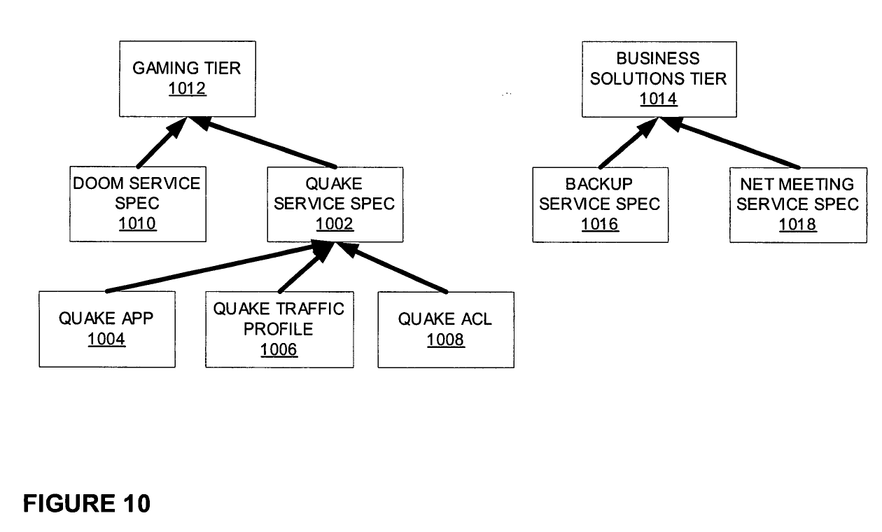

Turning attention to FIG. 10, QoS policies and profiles are described, in accordance with an embodiment of the invention. A QoS policy defines which subscribers are allowed access to premium networked applications, and the traffic characteristics with which they are associated. The process of differentiating network traffic can be viewed as two individual tasks: (1) defining and managing QoS policies which associate subscribers, applications, and traffic characteristics, and (2) configuring the network to recognize the aforementioned association. In order to define and manage QoS policies, the MSO identifies those applications to be supported for preferential QoS treatment and their appropriate application-specific traffic characteristics. The QoS policy can be restricted to a set of source and/or destination IP addresses that are defined in an access control list (ACL). The combination of one or more of an application, traffic characteristics, and/or ACL typically comprises a service specification or quality profile. Once the service specifications have been defined, the MSO can define tiers which are groups of service specifications. In FIG. 10, an on-line computer game's (e.g. Quake) service specification 1002 comprises the application name 1004, traffic profile 1006, and ACL 1008. Similar elements are defined for other service specifications. The Quake and Doom (another game) service specifications 1002, 1010 are grouped together to define an On-Line Interactive Game Tier 1012. Another tier, Business Solutions 1014, is also shown and comprises, for example a file back-up 1016 and Net Meeting 1018 service specification built in a manner similar to the game tier 1012. Once the tiers are established, the MSO defines which customers or groups of customers are subscribed to each of the tiers for which the QoS is guaranteed.

Application names are specified for the service specifications using two pieces of information: the application genre and an expression describing the application name, such as app*.exe. For example, the application genre, “WebBrowser”, may be used for browser applications, or “IM” might be used for instant messaging applications. In some embodiments of the invention, system QoS proxies use one or more expressions to detect an application when invoked. For example, the regular expression “ie*.exe” detects Internet Explorer launches. The FoxFire web browser could also be included in the WebBrowser application, and the expression “foxfire*.exe” can be the trap. If there are other web browsers to be included in the WebBrowser application, additional regular expressions can be added.

Traffic characteristics for applications preferably include information about the sustained bandwidth, bandwidth bursts, latency, and jitter that are to be used by the upstream and downstream connections that support the application. In some embodiments of the invention, traffic characteristics are determined in any one of several ways, including, but not limited to: default application profiles provided by the system developer; a QoS discovery analysis software tool; or MSO experience and experimental trials. The QoS discovery tool analyzes network traffic and determines the optimal application-specific QoS traffic characteristics. Traffic characteristics for both the upstream and downstream information flows can be defined.

In some embodiments of the invention, application-specific QoS can be restricted to specified endpoints, defined in terms of either the source or destination IP address and port number or URL. The list that defines permitted or restricted endpoints is called the Access Control List (ACL). For example, in the WebBrowser application genre, the IP address is preferably not restricted, but instead, the port number is restricted; the permitted IP addresses is defined as a wildcard, and only the port number is specified. Packets from the application with any IP address destination receive QoS over the HFC network, so long as the packet's destination port number is equal to the permitted port number defined in the ACL. For another application, such as the game application Quake, a specific endpoint is preferably defined. The endpoint can be an MSO game server, such that game-specific traffic would receive QoS over the HFC network. As such, an MSO can exclusively offer preferential handling of content that it owns and operates, resulting in both increased revenues and subscriber satisfaction. The MSOs can control the QoS of content riding over its HFC network by employing ACLs that define the list of source or destination addresses that are allowed as well as the list of source or destination addresses that are prohibited.

Some embodiments of the invention allow for the definition of service tiers. A tier of service is a set of service specifications that are offered as a product to customers. For example, an MSO can have a tier of service for on-line interactive games 1012 which bundles together the most popular games. A business services tier 1014 bundles together applications that small and medium businesses are most likely to use, such as remote file transfers, instant messaging, and video conferencing. Once the service tiers are defined, users can subscribe to one or more tiers of service. In an embodiment of the invention, groups of users are defined and service tiers are assigned to the group. For example, a subnet or group of subnets can be assigned to a tier such as “small business.”

In some embodiments of the invention, quality profiles are stored locally on subscribers' computing devices. The local storage of quality profiles allows a first level of admission control to be performed at the subscriber machine, rather than burdening the central application manager and policy server with potentially unnecessary requests. The quality profiles are preferably updated at startup or on a periodic basis, ensuring that QoS requests for the subscriber are current with the subscriber's subscription and application requirements. Subscriber computing devices use the locally stored profiles to make only appropriate QoS requests, and to make those requests with detailed requirements, including, for example, bandwidth, latency, jitter, burst rates, etc., facilitating optimal scheduling of QoS by the network services provider.

Policies are preferably configured through a web portal interface to the central application manager. The MSO can input the authorized applications, traffic profiles, ACLs, service specifications. The policies are configured in the web portal and are then combined into service specifications. Tiers are configured using the service specifications. Subscriber information is either configured via a web interface, or can be retrieved from the MSO's subscriber database. Once the subscriber information is retrieved, a list of tiers can be configured for each subscriber. It is also possible to define groups of subscribers by defining subnets or groups of subnets. In order to allow easy machine-to-machine access to these management tools, such as the MSO's provisioning system, the configuration of QoS policies can also be defined as Web Services in a published web services description language specification. Complementary OSS functions can use these Web Services to integrate the application manager functionality into the MSO's overall management strategy.

Because policies change over time, the MSO can review the policy information and add, change, or delete individual elements via the web interface, in some embodiments of the invention. For example, if an MSO has been using a default traffic profile for a particular game, and has since discovered a more effective profile, it can easily edit the game's traffic profile. Similarly, it is possible to add service specifications to the on-line interactive gaming tier as new computer games become available. The web services enables the MSO to offer subscribers self-provisioning capabilities such as adding and deleting tiers, as well as listing the tiers for which the subscriber is assigned. And, of course, it is possible for the MSO to add subscribers to new services, remove subscribers, and change the definitions of groups of subscribers.

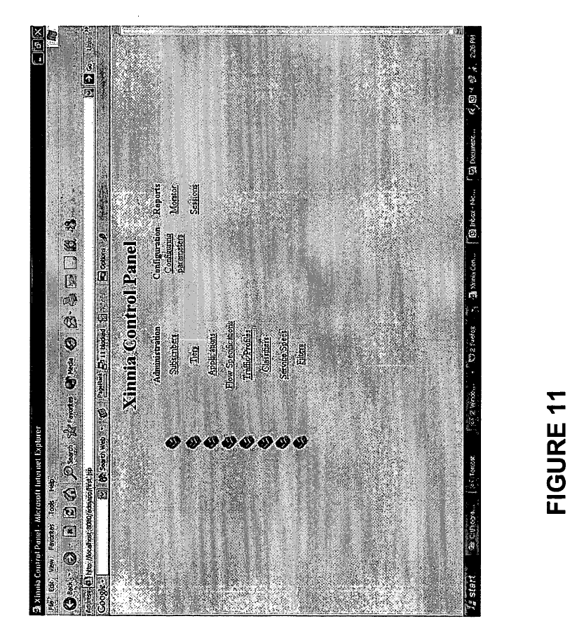

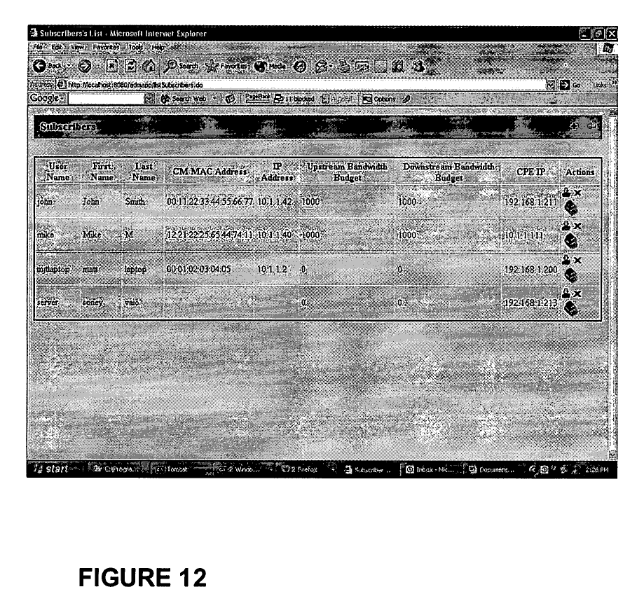

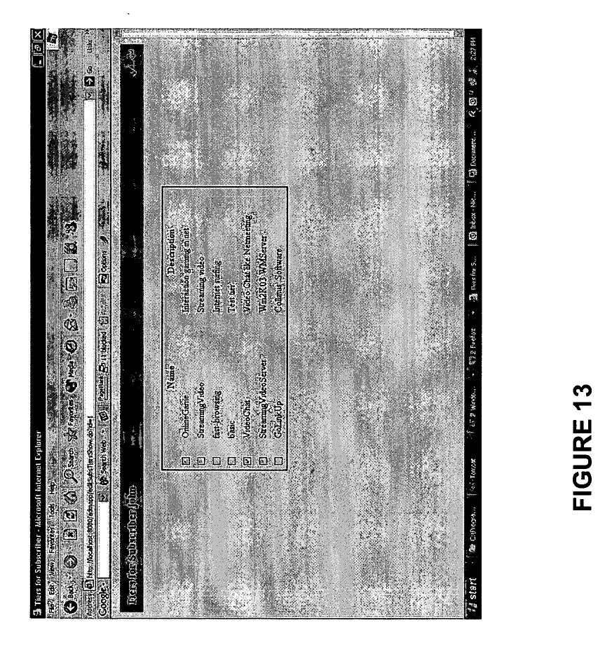

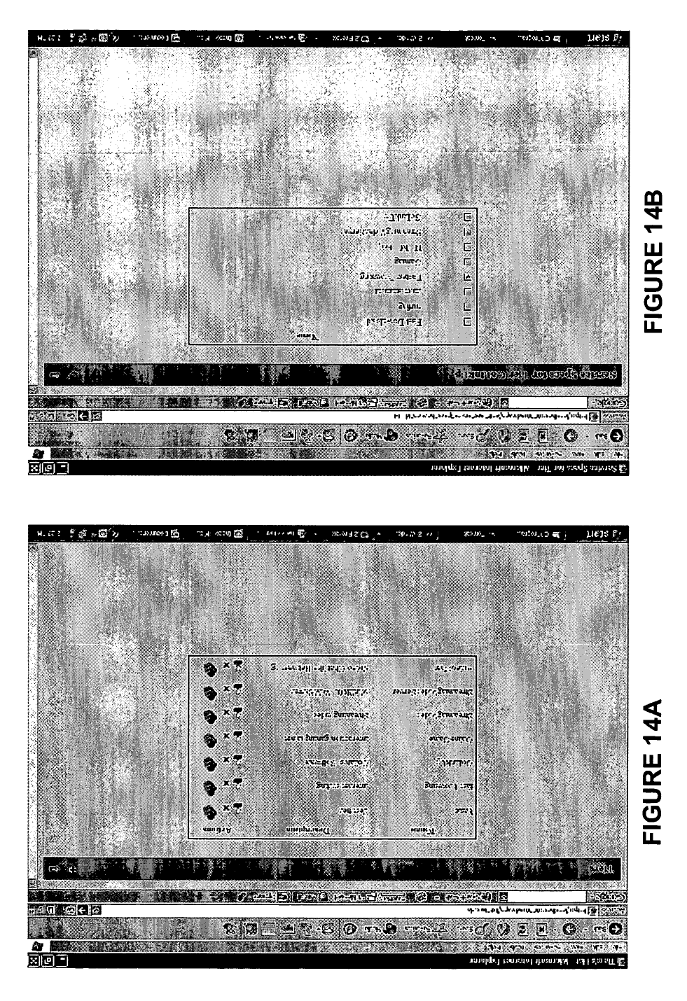

As described above, the subscriber policies and application information can easily be customized by the MSO, in some embodiments of the invention, using a simple Web portal or web services to the provisioning system. Such an interface enables the MSO to manage subscribers, tiers, applications and services, and QoS profiles. New application-specific QoS profiles can be easily designed using a “profile builder”. An exemplary web interface for managing subscribers, tiers, applications and services is shown in FIGS. 11-20, in accordance with an embodiment of the invention. FIG. 11 is a main menu presenting options for administering a QoS management system. FIG. 12 shows a submenu for editing and creating subscribers, including relevant information such as MAC address, IP address and budgeted bandwidth. The submenu of FIG. 13 is used to assign a particular subscriber to one or more tiers of service, such as an OnlineGaming tier or VideoChat tier. Tiers themselves are edited and created through a submenu as shown in FIG. 14A. In the submenu shown in FIG. 14B, application groups (service specs) can be bundled to define a service tier, such as the “GoLinkUp” tier shown.

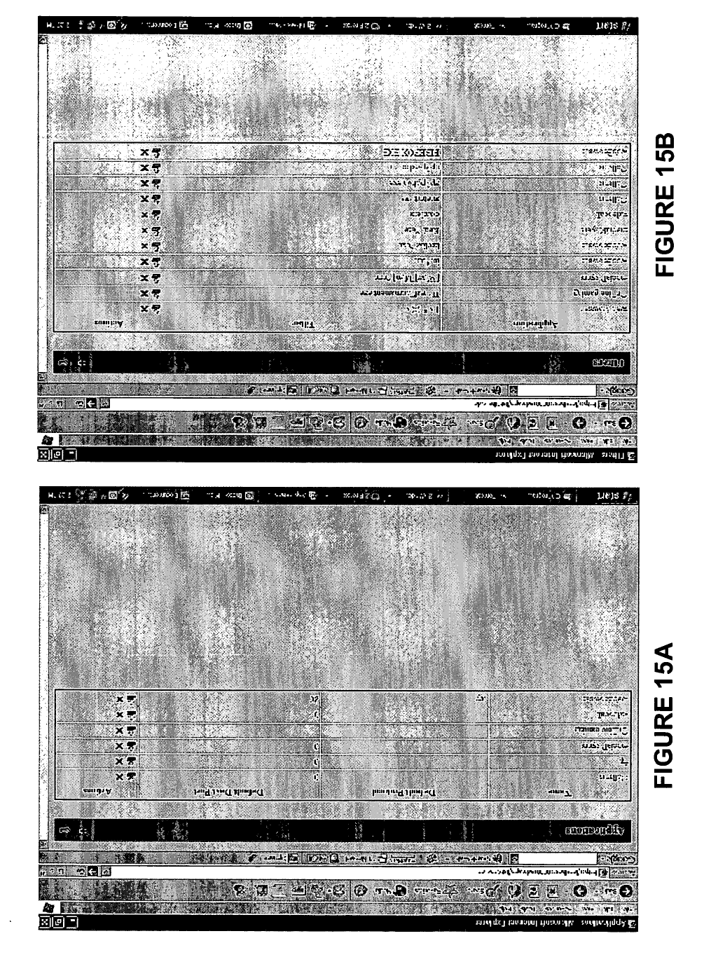

In FIG. 15A, a submenu allows application groups to be created and edited. The individual applications comprising an applications group can be edited in a filtering submenu as shown in FIG. 15B. The filters allow recognition of multiple representations of the use of a group's included applications through the use of multiple listings and regular expressions.

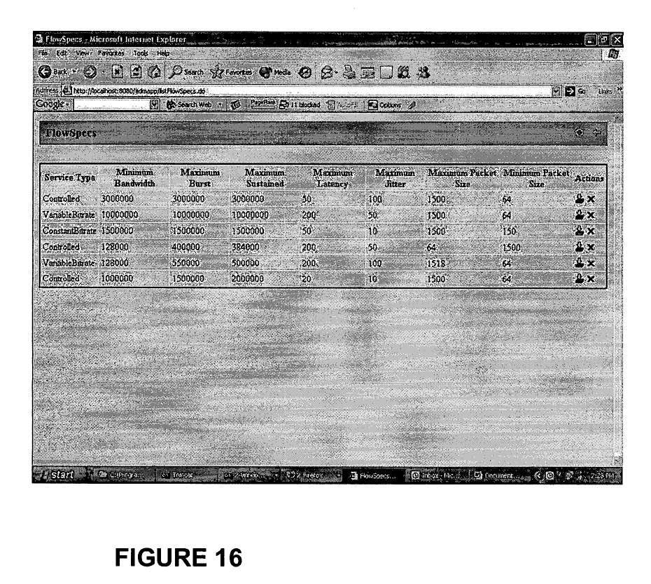

Traffic flow specifications can be edited and created through a submenu as shown in FIG. 16. Traffic flow specifications are one of the components of QoS, and the flow specification describes the particular transmission parameters for QoS.

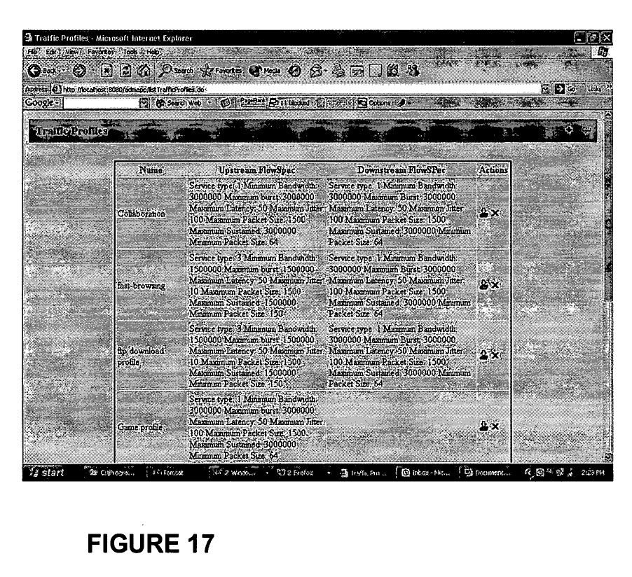

Traffic profiles are created and edited with a submenu such as the one shown in FIG. 17. Traffic profiles are pairs of flow specs (one for upstream, one for downstream) and get associated with a type of service.

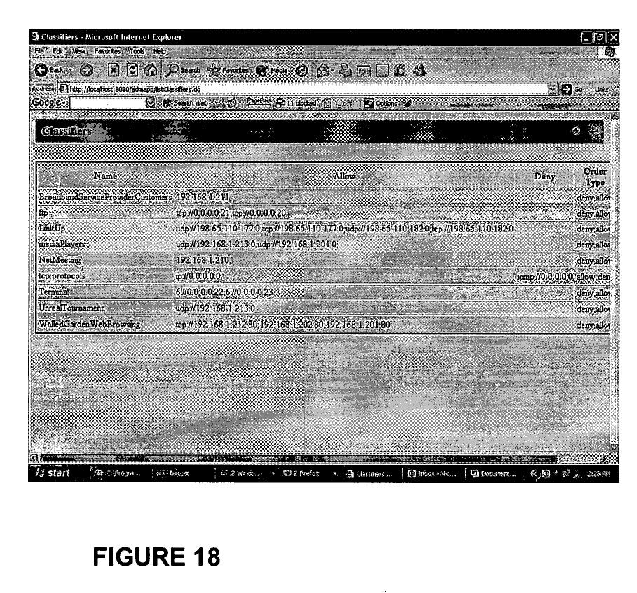

Flow classifiers are edited and created through a submenu such as that shown in FIG. 18. Flow classifiers are used to define the end-point of the flow. In some embodiments of the invention, it is assumed that one of the two endpoints of a flow is where the system QoS proxy is running.

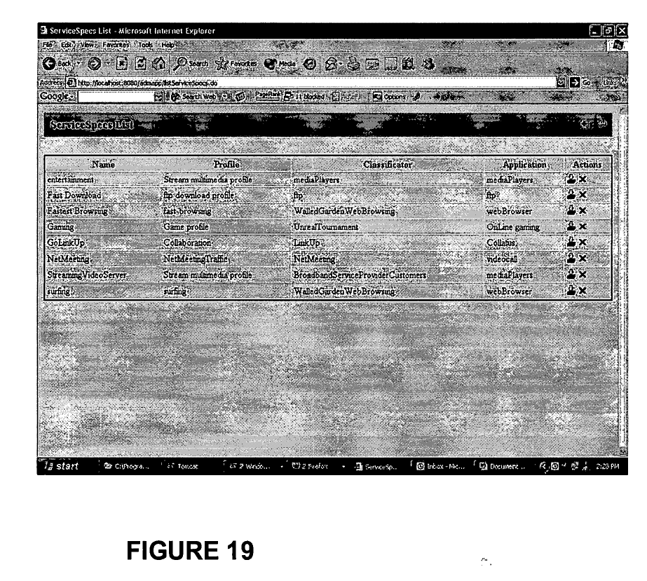

The service specifications bind traffic profile, flow classifier, and application group, and are edited and created in a submenu as shown in FIG. 19.

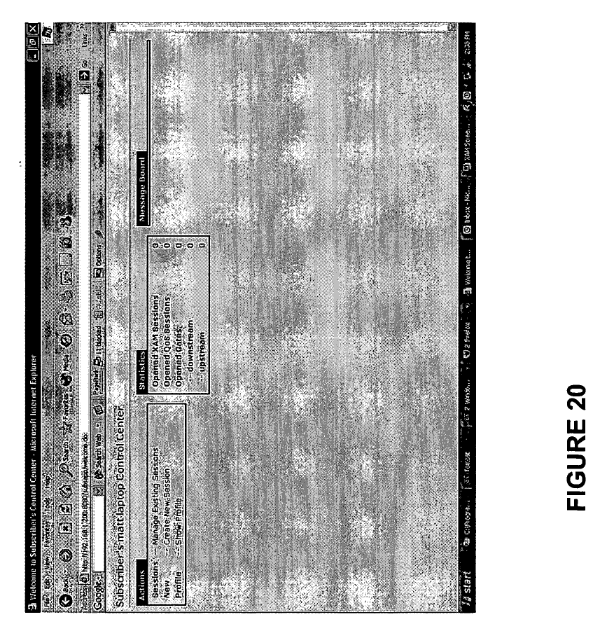

Additionally, some monitoring and management for QoS may be performed at the subscriber's computing device through the use of a web interface, according to some embodiments of the invention. For example, a subscriber can use the interface of FIG. 20 to see usage statistics regarding sessions with the central AppMgr, including those resulting in establishment of QoS, and more particularly statistics regarding any upstream and downstream gates opened for the subscriber.

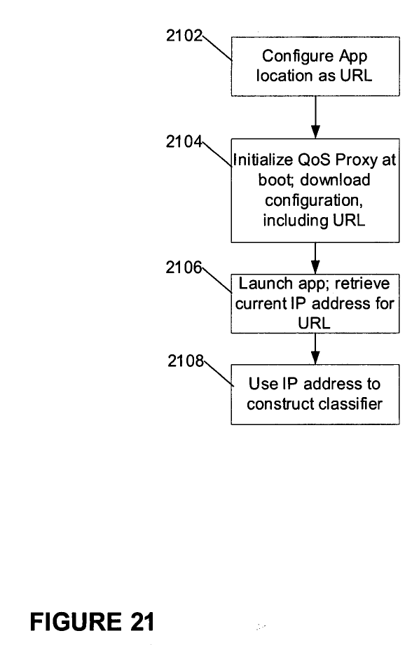

In some situations, the network IP address from which specific content is retrieved by the subscriber computing devices varies from one subscriber to the next, based upon various factors such as the subscriber's location and placement of content caches. That is, two subscribers connecting to a server using identical URLs may actually be routed to different caches of the server. Furthermore, the location from which a particular subscriber retrieves data may vary over time depending on factors such as network congestion, failures and reconfigurations. Thus, if configuration of classifiers for service flows is based solely on network addresses, specific configurations would need to be made for each user, and these configurations would have to be updated whenever the location of the content was changed. Some embodiments of the invention solve this problem by altering the IP address for an application's URL returned from the local name server. The system QoS proxy residing on the subscriber's computing device uses the URL (rather than the IP address) to configure the classifiers for a service flow. This process is performed at the time the content is requested, so that the most up-to-date location is used. FIG. 21 illustrates a method for finding the current location, as used in some embodiments of the invention. The location of an application for a specific subscriber is configured as a URL in the centrally located AppMgr at step 2102. When the subscriber boots his computing device, it initializes its system QoS proxy and downloads the configuration information from the AppMgr, including the URL for the application at step 2104. QoS profiles are further updated at regular timed intervals to ensure they are up-to-date. When the subscriber launches the application, the system QoS proxy retrieves the current IP address of the URL from the local domain name server at step 2106. The system QoS proxy then uses this IP address when constructing the classifier to be used with the service flow at step 2108.

In order to update QoS profiles at regular intervals, the QoS proxy preferably communicates with the AppMgr with a Keep-Alive message to maintain state information. One element of the message is the current policy configuration for the subscriber. If the QoS proxy detects a QoS profile is not current due to an edit or change at the AppMgr, the QoS proxy requests an updated policy configuration.

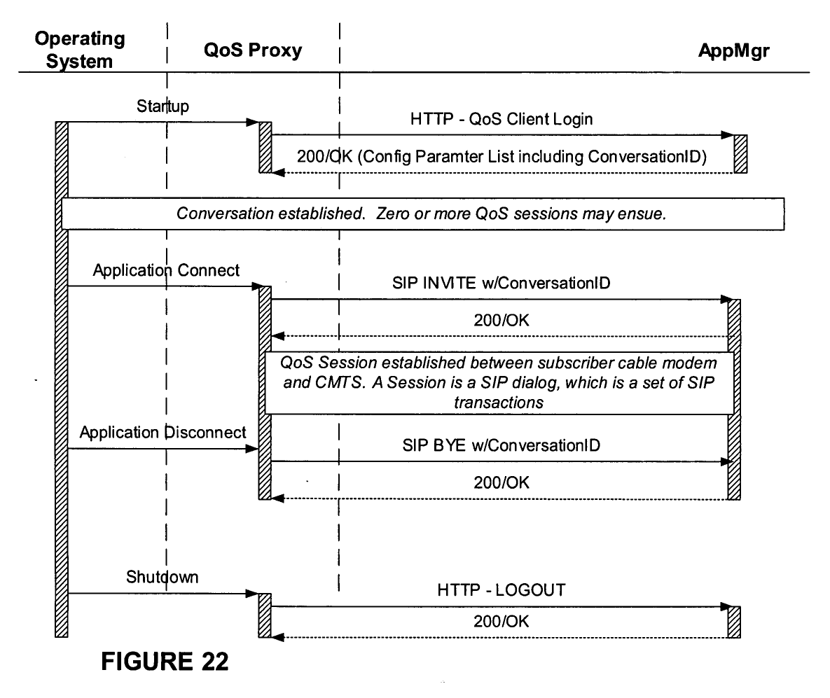

Additional details are now provided with respect to the communications interface between a system QoS proxy and an AppMgr, as used in some embodiments of the invention. The interface is designed to use the Session Initiation Protocol (SIP) and the Secure Session Initiation Protocol (SIPS). The transaction between the client (i.e., the machine hosting the system QoS proxy) and the AppMgr is modeled after the RFC 3264 (An Offer/Answer Model with Session Description Protocol (SDP)), and RFC 3312 (Integration of Resource management and SIP) which are hereby incorporated by reference for all that they teach without exclusion of any part thereof. A basic QoS session establishment between the QoS proxy and the AppMgr is shown in FIG. 22. FIG. 22 shows a series of communications between the QoS proxy and the AppMgr to establish a QoS session. In the following description, a “SIP Transaction” is defined according to RFC 3261, and comprises a single request and any responses to that request, including zero or more provisional responses and one or more final responses. A “SIP Dialog” is defined according to RFC 3261 and comprises a set of SIP transactions between two SIP components that have the same dialog ID. A “QoS Session” is a DOCSIS service flow (which is the equivalent of a virtual circuit in X.25) that is created as a result of the SIP dialog between the QoS proxy and the AppMgr to establish and remove a PCMM gate for a QoS proxy request. A “Conversation” is the envelope that encompasses one or more QoS Sessions between the QoS proxy and the AppMgr. A conversation starts once the login response is received by the QoS proxy from the AppMgr, and includes all the SIP dialogs for the QoS sessions.

In some embodiments of the invention, all transactions between the client and the AppMgr preferably use SIP version 2 (SIP/2.0). The interface supports the use of various SDP parameters (descriptors), including many at the Session Level, and many at the Media Level.

At the Session Level, the interface supports a protocol version parameter (v=). As per RFC 2327, the protocol version parameter is used to represent the version of the interface definition. Currently this is set to “0” (zero), but will be incremented as future versions of this interface definition are released.

The interface also supports an Owner parameter (o=). As per RFC 2327, the parameter takes several arguments of the form: O=<username><session id> <version> <network type> <address type> <address>. For all transactions, <username> contains the user's login that was used during the registration. As per RFC 2327, the <username> does not contain any spaces. The AppMgr verifies that the tuple, <session id> <version> <network type> <address type> <address> is unique, in order to prevent the processing of duplicate QoS requests. In the cases of a duplicate request the AppMgr responds with a response code of 491. <session id> and <version> are 10-digit Network Time Protocol (NTP) timestamps as per RFC 2327. <network type> is “IN” to indicate Internet, as per RFC 2327. <address type> is “IP4” to indicate IP version 4 as per RFC 2327. <address> is the public IP address of the sender as per RFC 2327. The address is preferably sent in the dotted-decimal representation of the IP address. Thus, when the client is behind a NAT router, it must determine the IP address that is assigned to the NAT router and not the IP address that was assigned the client by DHCP server running on the NAT router. Some embodiments of the invention include a STUN server that provides the QoS proxy with an appropriate IP address for classification. A STUN server can be included at the AppMgr or at a third party site located elsewhere on the Internet. The QoS proxy configuration includes an entry for a URL to the STUN server.

The interface also supports a Session Name parameter (s=), which is “−” to indicate no session name as per RFC 2327.

The interface also supports a Connection Information parameter (c=). As per RFC 2327, the Connection Information parameter takes several arguments of the form c=<network type> <address type> <connection address> where <network type>=IN, <address type>=IP4, and <connection address>=dotted decimal formatted destination IP address for session.

The interface further supports a Times parameter (t=). As per RFC 2327, t=<start time> <stop time> where the <start time> and <stop time> are set to 0 to indicate permanent and unbounded.

At the media level, the interface preferably supports several parameters, as per RFC 2327. A Media Name parameter (m=) takes the form m=<media> <port> <transport> <fmt list>. The <media> argument may take the values of “audio”, “video”, “application”, “data”, and “control”. The media fill is always be set to “application”. The <port> argument is the port that the media will be sent. The <transport> argument specifies the transport protocol. Supported protocols include udp-17, tcp-6, authentication header (AH)-51 and Encapsulating Security Payload (esp)-50. The <fmt list> argument is set to 0.

The interface further preferably supports additional SDP parameters as defined by RFC 3312, which are used when reserving network resources. In some embodiments of the invention, the interactions between the QoS proxy and the AppMgr use a subset of the parameters, as listed below. No further additional parameters are preferably used. A Desired Status parameter (a=des:) is included in an INVITE request, and includes the desired status for the QoS. The Desired Status parameter takes the form: “a=des:” <precondition type> <strength-tag> <status-type> <direction-tag> (e.g., “a=des:qos mandatory local send”). The Precondition Type argument only accepts the value “qos” according to RFC 3312, but some embodiments of the invention extend the range of accepted values. The Strength Tag argument for all transactions is set to “mandatory”. The Status Type argument for all transactions is set to “local” to indicate the segment from the cable modem to the CMTS. The Direction Type argument is set by the client will set to indicate the direction(s) required to the best of its ability: Send=Upstream direction; Recv=Downstream direction; and Sendrecv=Upstream and Downstream.

Some embodiments of the invention define and support additional SDP parameters to allow the AppMgr to determine the QoS requirements for the session. These attributes are formatted as per RFC 2327 attributes, a=<attribute>:value. These additional parameters include an Application Name parameter, where the parameter takes the form “a=application:”

<application name>. The application name parameter is used by the client to indicate the name of the application running on the client machine that triggered the QoS request. An additional parameter is a Configuration Version parameter taking the form “a=configVersion:”<version ID>. The client includes the version value in the request to allow the AppMgr to keep the client's configuration synchronized with any changes made by the administrators. Another additional parameter is a Conversation ID parameter of the form

“a=conversationId:”<conversationID>. The client includes in the request the conversationID from the configuration data it received when it logged in to the AppMgr. Still another additional parameter is a Traffic Profile parameter of the form “a=traffic-profile:”<traffic-profile-name>. The values for traffic profile are consistent with the profile received in the client's configuration file at the time of the registration. Yet another additional parameter is a set of Traffic Classifier parameters, including: a Source IP parameter (“a=source-ip:”<dotted decimal IP address>); a Source Port parameter (“a=source-port:”<port #>); a Destination IP parameter (“a=destination-ip:”<dotted decimal IP address>); a Destination Port parameter (“a=destination-port:”<port #>); and a Protocol parameter (“a=protocol:”<IP Protocol number>). As defined by RFC 2327, this is the transport protocol. Supported protocols include: udp-17; tcp-6; authentication header (AH)-51; and Encapsulating Security Payload (esp)-50.

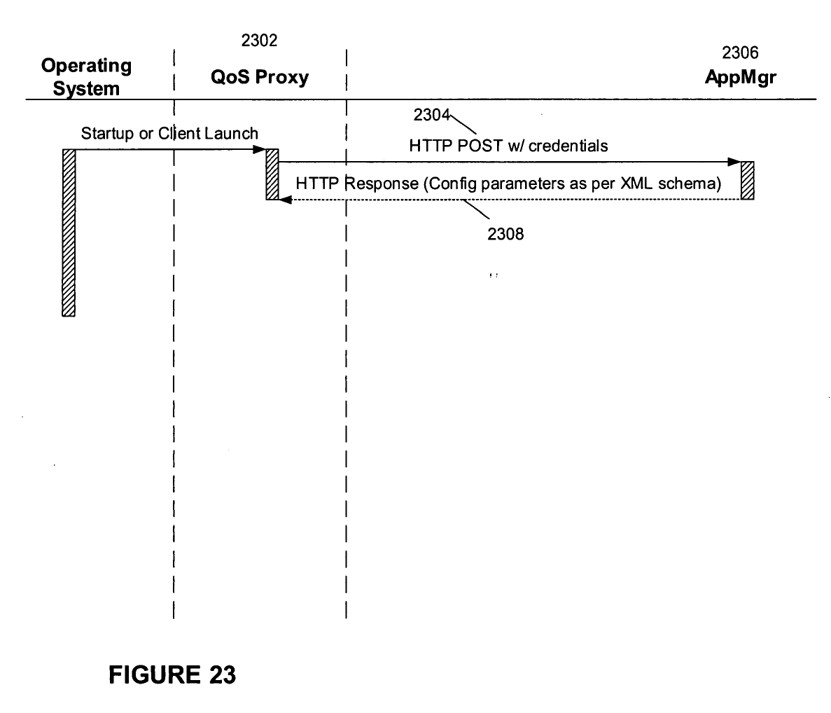

Turning attention to FIG. 23, an initiation and/or periodic sequence is shown for configuring a subscriber computing device running a system QoS proxy to make future application-specific QoS requests, as used in an embodiment of the invention. The initiation sequence and/or periodic sequence between the client and server includes the client 2302 sending an HTTP POST 2304 to the fully qualified domain name (FQDN) that is configured on the client. The POST message 2304 contains a set of name/value pairs to register with the AppMgr 2306, as shown in Table 2.

TABLE 2

| Property Name | Value |
|---|---|
| “local ip address” | The local IP address of the machine in |
| | dotted-decimal format. |
| “config file version” | The value of the “configVersion” from the |
| | last good registration response. |
| “client version” | The software version of the client. |
| “os version” | A string indicating the version of the OS. |

In response to the POST 2304, if the subscriber is authorized, the AppMgr 2306 responds with a response 2308 with the client's configuration information as the payload. The response 2308 is preferably formatted to conform to the XML schema in Appendix A. Alternatively, a web services SOAP/XML message is sent instead of a POST 2304, using the same underlying parameters.

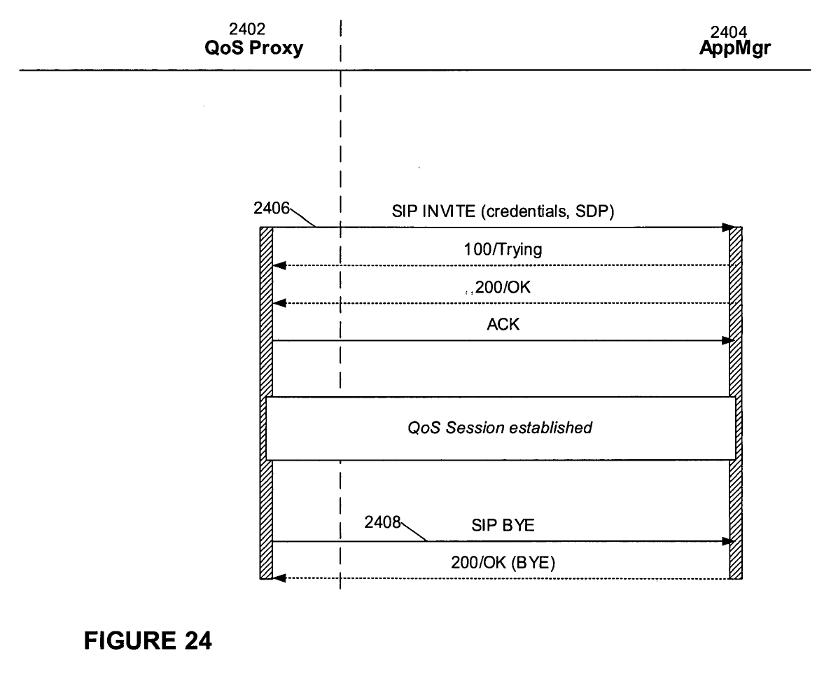

In FIG. 24, an exemplary QoS transaction is shown, in accordance with an embodiment of the invention. There is one transaction defined between the client 2402 and the AppMgr 2404. The client initiates an INVITE transaction 2406 whenever it detects an event that requires network QoS. The client terminates the session with a BYE 2408 when it detects that the session is no longer needed. An example SDP Media Session Description contains:
v=0
o=alice 2890844526 2890844526 IN IP4 client.atlanta.example.com

s=−
c=IN IP4 192.0.2.1
t=0 0
m=application 49172 upd 0
a=des:qos mandatory local sendrecv
a=application:wm9.exe
a=configVersion:1
a=conversationId: 1234567890
a=traffic-profile:streamingvideo
a=source-ip:68.52.0.15
a=source-port:4518
a=destination-ip:147.135.4.128
a=destination-port:6072
a=protocol:udp

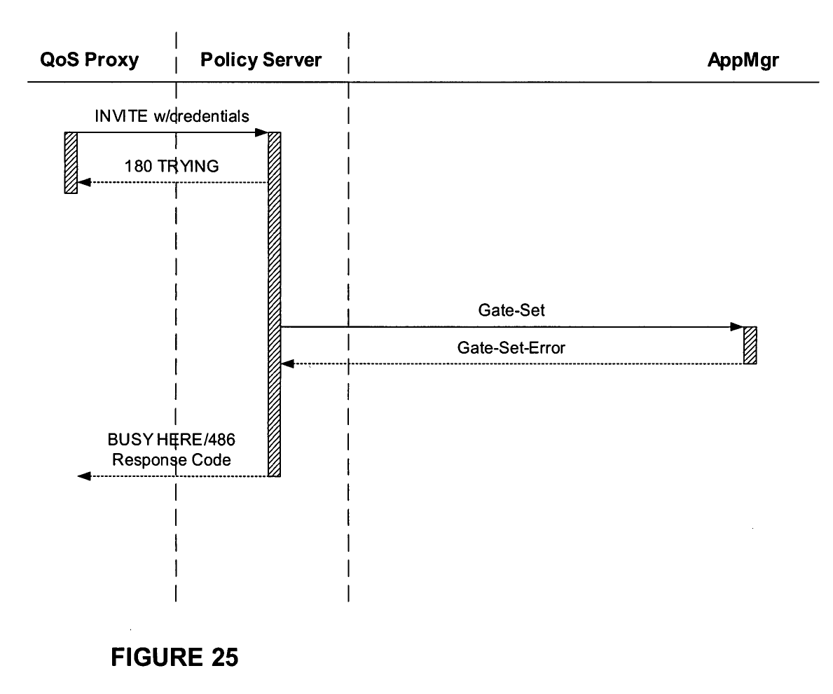

For the cases when the AppMgr is not able to honor the request, the AppMgr preferably responds with an error code as per RFC 3261. Such an example of an error is shown in FIG. 25. In general, RFC 3261 groups the response codes into the following groups:
1xx—Information Responses
2xx—Successful Responses
3xx—Redirection Responses
4xx—Request Failure Responses
5xx—Server Failure Responses
6xx—Global Failure Responses

In some embodiments of the invention, the AppMgr uses response codes as shown in Table 3.

TABLE 3

| Reason | | |
|---|---|---|
| Code | Description | Usage |
| 100 | Trying | Acknowledgement of an INVITE by the |
| | | AppMgr |
| 183 | Session Progress | Indication that QoS request has been |
| | | forwarded to the Proxy Server for |
| | | processing |
| 200 | OK | QoS Request honored |
| 380 | Alternative | The original QoS request could not be |
| | Service | honored, but the service described in |
| | | the response is available. (Beta) |
| 400 | Bad Request | As per RFC 3261 |
| 401 | Unauthorized | As per RFC 3261 |
| 403 | Forbidden | As per RFC 3261 |
| 407 | Proxy | As per RFC 3261 |
| | Authentication | |
| | Required | |
| 480 | Temporarily | The AppMgr shall respond with a 480 |
| | Unavailable | whenever a rule within the Admission |
| | | Control engine is fired that denies or |
| | | forbids the request. |
| 486 | Busy Here | As per RFC 3261, whenever the AppMgr |
| | | gets a Gate-Set-Error indicating that |
| | | the Policy Server/CMTS could not honor |
| | | the request due to resource |
| | | contentions. |
| 491 | Request Pending | As per RFC 3261 |
| 500 | Server Internal | As per RFC 3261 |
| | Error | |
| 501 | Not Implemented | As per RFC 3261 |
| 503 | Service | As per RFC 3261 |
| | Unavailable | |

An XML schema for a Client Configuration Payload is attached as Appendix A.

The present invention is not limited to those embodiments described above. For example, in one embodiment, a high-quality communications session is established between two subscriber computing devices in a peer-to-peer configuration. In this scenario, embodiments of the invention invoke “pipe matching” techniques to ensure that each subscriber's QoS requirements are compatible. In another embodiment, the system QoS proxy uses an automatic detection protocol such as Universal Plug n' Play (UPnP) to allow QoS requests to be made on behalf of devices connected locally to the subscriber computing device running the QoS proxy. For example, a networked digital video recorder is detected by the subscriber computing device's QoS proxy via UPnP, and a QoS request is sent on its behalf.

Additionally, some embodiments of the invention are used within a local wireless network operating according to an IEEE 802.11e standard. In such embodiments, TOS/DS bits are marked in packets sent to and from the QoS-requesting application to indicate a higher priority that those packets should receive within the local wireless network. The wireless router honors the priorities set of these bits. Some embodiments of the invention can thus be used even over dedicated, non-shared networks such as DSL, to ensure subscribers receive desired QoS relative to other users on the local wireless network, or relative to other applications running on the subscriber's computing device.

In another embodiment of the invention, a communications session over a WIMAX or “broadband wireless” medium is made high-quality through the use of bit-marking or coloring. The system quality proxy on the subscriber computing device marks DS/TOS bits in the upstream direction, while a remote content or application server (e.g., operated by the network services provider) marks DS/TOS bits in the downstream direction. The subscriber's wireless modem and the service provider's wireless router place packets in queues according to the priority set by the DS/TOS bits. The AppMgr can be used for authentication and admission control, such that the system quality proxy on the subscriber's computing device intercepts a network call by an application and makes a request for QoS according to locally stored policies. If the user and application are authenticated, the AppMgr instructs the quality proxy to mark its TOS/DS bits, and instructs the content or application server to similarly mark its TOS/DS bits for the subscriber. Bit coloring is also used in this manner in some embodiments of the invention over networks other than WIMAX or broadband wireless that are policy based and honor bit coloring protocols.

In view of the many possible embodiments to which the principles of the present invention may be applied, it should be recognized that the embodiments described herein with respect to the drawing figures are meant to be illustrative only and should not be taken as limiting the scope of the invention. Additionally, those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

APPENDIX A - XML SCHEMA for Client Configuration Payload

<?xml version=“1.0” encoding=“utf-8”?>
<xs:schema
targetNamespace=“http://www.xinniatech.com/2004/AppMgr2Client”
elementFormDefault=“qualified”
attributeFormDefault=“unqualified” version=“1”
xmlns:xs=“http://www.w3.org/2001/XMLSchema”
xmlns=“http://www.xinniatech.com/2004/AppMgr2Client”>

<xs:complexType name=“aclType”>

<xs:choice>

<xs:element name=“all”>

<xs:simpleType>

<xs:restriction base=“xs:string”>

<xs:enumeration value=“”/>

</xs:restriction>

</xs:simpleType>

</xs:element>
<xs:element name=“destination” type=“destinationType”

maxOccurs=“unbounded”/>

</xs:choice>

</xs:complexType>
<xs:complexType name=“deployableComponentType”>

<xs:sequence>

<xs:element name=“version” type=“xs:string”/>
<xs:element name=“location” type=“xs:anyURI”/>

</xs:sequence>

</xs:complexType>
<xs:element name=“config”>

<xs:annotation>

<xs:documentation>Object contained in configuration file

retrieved by the client from the AppMgr.</xs:documentation>

</xs:annotation>
<xs:complexType>

<xs:sequence>

<xs:element name=“version” type=“xs:string”>

<xs:annotation>

<xs:documentation>Version number for config file

for this customer to be used to sync with
AppMgr.</xs:documentation>

</xs:annotation>

</xs:element>
<xs:element name=“conversationId” type=“xs:token”>

<xs:annotation>

<xs:documentation>Unique token generated by the

AppMgr.</xs:documentation>

</xs:annotation>

</xs:element>
<xs:element name=“server”

type=“deployableComponentType”/>

<xs:element name=“client”

type=“deployableComponentType”>

<xs:annotation>

<xs:documentation>Used by client to see if it

needs to do a software upgrade</xs:documentation>

</xs:annotation>

</xs:element>
<xs:element name=“keep-alive” type=“xs:int”>

<xs:annotation>

<xs:documentation>Keep-Alive timer

value</xs:documentation>

</xs:annotation>

</xs:element>
<xs:element name=“catalog” minOccurs=“0”>

<xs:complexType>

<xs:sequence>

<xs:element name=“application”

maxOccurs=“unbounded”>

<xs:complexType>

<xs:sequence>

<xs:element name=“app-name”>

<xs:annotation>

<xs:documentation>This is a set

of regular expression filters to be used by the client to
determine if the application is making a
request.</xs:documentation>

</xs:annotation>
<xs:complexType/>

</xs:element>
<xs:element name=“filter”

type=“xs:string” maxOccurs=“unbounded”>

<xs:annotation>

<xs:documentation>Regular

Expression to do pattern matching to create many
filters</xs:documentation>

</xs:annotation>

</xs:element>

</xs:sequence>

</xs:complexType>

</xs:element>
<xs:element name=“traffic-profile”

maxOccurs=“unbounded”>

<xs:annotation>

<xs:documentation>The absence of a

flowSpec for a respective direction means that there is no QoS
for that direction and all traffic in that direction will be
treated as “Best-effort”.</xs:documentation>

</xs:annotation>
<xs:complexType>

<xs:sequence>

<xs:element name=“traffic-profile-

name”>

<xs:annotation>

<xs:documentation>This is the

name of the tier. It is the same name as the tier field for the
application and used to cross-reference betweent the applicatoin
and tier.</xs:documentation>

</xs:annotation>

</xs:element>
<xs:element name=“UpstreamFlowSpec”

type=“flowSpecType” minOccurs=“0”>

<xs:annotation>

<xs:documentation>If this is

present then the client may request QoS for the Upstream
direction.</xs:documentation>

</xs:annotation>

</xs:element>
<xs:element name=“DownstreamFlowSpec”

type=“flowSpecType” minOccurs=“0”>

<xs:annotation>

<xs:documentation>If this is

present then the client may request QoS for the Downstream
direction.</xs:documentation>

</xs:annotation>

</xs:element>

</xs:sequence>

</xs:complexType>

</xs:element>

</xs:sequence>

</xs:complexType>

</xs:element>
<xs:element name=“qos-tier”>

<xs:complexType>

<xs:sequence>

<xs:element name=“tier_name”/>
<xs:element name=“service-spec” minOccurs=“0”

maxOccurs=“unbounded”>

<xs:complexType>

<xs:sequence>

<xs:element name=“service-spec-name”

type=“xs:string”>

<xs:annotation>

<xs:documentation>The name of the

tier that is associated with this application and that the
Client should supply in the QoS request to the AppMgr for this
application</xs:documentation>

</xs:annotation>

</xs:element>
<xs:element name=“traffic-profile-

name”/>

<xs:element name=“app-name”/>
<xs:element name=“access-control-

list”>

<xs:annotation>

<xs:documentation>The classifier

should work similar to how the access list works for
Apache.</xs:documentation>

</xs:annotation>
<xs:complexType>

<xs:sequence>

<xs:element name=“order”

type=“orderType”/>

<xs:element name=“allow”

type=“aclType”/>

<xs:element name=“deny”

type=“aclType”/>

</xs:sequence>

</xs:complexType>

</xs:element>

</xs:sequence>

</xs:complexType>

</xs:element>

</xs:sequence>

</xs:complexType>

</xs:element>
<xs:element name=“maxBudgetedQoS”>

<xs:annotation>

<xs:documentation>This is the maximum total

bandwidth of all the QoS requests (i.e. Service Flows) that the
client may request. Once the client reaches this max it should
not request anymore until it removes a request. Likewise, the
AppMgr should refuse any additional requests.</xs:documentation>

</xs:annotation>
<xs:complexType>

<xs:sequence>

<xs:element name=“upstreamBandwidth”

type=“xs:int”/>

<xs:element name=“downstreamBandwidth”

type=“xs:int”/>

</xs:sequence>

</xs:complexType>

</xs:element>

</xs:sequence>

</xs:complexType>

</xs:element>
<xs:simpleType name=“orderType”>

<xs:restriction base=“xs:string”>

<xs:enumeration value=“allow,deny”/>
<xs:enumeration value=“deny,allow”/>
<xs:enumeration value=“mutual-failure”/>

</xs:restriction>

</xs:simpleType>
<xs:complexType name=“destinationType”>

<xs:sequence>

<xs:element name=“port” type=“xs:integer”/>
<xs:element name=“address” type=“addressType”/>
<xs:element name=“protocol”/>

</xs:sequence>

</xs:complexType>
<xs:simpleType name=“addressType”>

<xs:union memberTypes=“xs:string xs:string xs:string”/>

</xs:simpleType>
<xs:simpleType name=“serviceType”>

<xs:restriction base=“xs:string”>

<xs:enumeration value=“Controlled”/>
<xs:enumeration value=“ConstantBitRate”/>
<xs:enumeration value=“VariableBitRate”/>

</xs:restriction>

</xs:simpleType>
<xs:complexType name=“flowSpecType”>

<xs:sequence>

<xs:element name=“direction”/>
<xs:element name=“serviceType” type=“serviceType”/>
<xs:element name=“minBandwidth”/>
<xs:element name=“maxBurst”/>
<xs:element name=“maxSustained”/>
<xs:element name=“maxLatency”/>
<xs:element name=“maxJitter”/>
<xs:element name=“maxPacketSize”/>

</xs:sequence>

</xs:complexType>

</xs:schema>

1. A method for use by a content server in establishing a high-quality network connection communications session between a software application running on a subscriber computer and a network service provider, the method comprising:
receiving a request from the software application on the subscriber computer;
responding to the request with a network call from an application server running on the content server, the application server associated with software applications of the type running on the subscriber computer;
capturing the network call with a quality proxy agent running on the content server;
obtaining a network quality profile corresponding to the software application;
identifying, by the quality proxy agent, the subscriber associated with making the request;
verifying that the subscriber is authorized to request a high-quality network connection for the software application;
causing to be transmitted to the network service provider a request for a high-quality network connection communications session on behalf of the software application running on the subscriber computing device, according to the quality profile;
whereby, after the network service provider has processed the request, communications between the software application and the network service provider are of a quality satisfying the requirements of the quality profile; and the method further comprising:
in response to a terminating event, causing to be transmitted to the network service provider a request to terminate the high-quality network connection communications session.

2. The method of claim 1 wherein the quality profile comprises requirements for a combination of one or more of bandwidth, latency and jitter.

3. The method of claim 1 further comprising:
identifying, by the quality proxy agent, the software application; and
verifying that the software application is authorized for high-quality network connections.

4. A method for use by a system quality proxy agent running on a subscriber computer for establishing a high-quality network connection communications session between an object associated with the subscriber computer and a network service provider, the method comprising:
capturing a network call from the object;
identifying the object associated with making the network call;
obtaining a network quality profile corresponding to the object;
verifying that the object is authorized to request a high-quality network connection; and
causing to be transmitted to the network service provider a request for a high-quality network connection communications session according to the quality profile;
whereby, after the network service provider has processed the request, communications between the object and the network service provider are of a quality satisfying the requirements of the quality profile.

5. The method of claim 4 wherein the quality profile comprises requirements for a combination of one or more of bandwidth, latency and jitter.

6. The method of claim 4 further comprising:
identifying the user of the object; and
verifying that the user is authorized to request a high-quality network connection for the object;
wherein the quality profile further corresponds to the verified user.

7. A computer-readable medium including computer-executable instructions facilitating establishing a high-quality network connection communications session between a software application running on a subscriber computer and a network service provider, the computer-executable instructions performing the steps of:
capturing a network call from the software application running on the subscriber computer;
identifying the software application associated with making the network call;
obtaining a network quality profile corresponding to the software application;
verifying that the software application is authorized to request a high-quality network connection; and
causing to be transmitted to the network service provider a request for a high-quality network connection communications session according to the quality profile;
whereby, after the network service provider has processed the request, communications between the software application and the network service provider are of a quality satisfying the requirements of the quality profile.

8. The computer-readable medium of claim 7, wherein the quality profile comprises requirements for a combination of one or more of bandwidth, latency and jitter.

9. The computer-readable medium of claim 7 wherein the quality profile comprises a stream or packet classifier.

10. The computer-readable medium of claim 7 wherein the quality profile is obtained from a local storage on the subscriber computer.

11. The computer-readable medium of claim 7, the computer-executable instructions further performing the steps of:
identifying the user of the software application; and
verifying that the user is authorized to request a high-quality network connection for the software application;
wherein the quality profile further corresponds to the verified user.

12. The computer-readable medium of claim 7, wherein the request for a high-quality network connection communications session comprises a TOS/DS mark for designating the priority of communications packets in the session.

13. A method for establishing a high-quality network connection communications session between a software application running on a subscriber computer and a network service provider, the method comprising:
receiving a request for a high-quality network connection on behalf of the subscriber computer, the request caused by a system quality proxy agent residing on either the subscriber computer or a content server contacted by the subscriber computer, the proxy agent having obtained a quality profile for the software application, and the request comprising information about the software application according to the quality profile;
authenticating the request;
obtaining policy information corresponding to the request; and
granting a high-quality network connection communications session to the subscriber computer for communications with the application according to the policy information.

14. The method of claim 13 wherein the quality of the communications session is measured according to a combination of one or more of bandwidth, latency and jitter.

15. The method of claim 13 wherein the system quality proxy agent performs the steps of:
capturing a network call from the software application running on the subscriber computer;
identifying the software application associated with making the network call;
verifying that the software application is authorized to request a high-quality network connection; and
causing to be transmitted to the network service provider the request for a high-quality network connection communications session according to the quality profile.

16. The method of claim 13 wherein the request further comprises information about the user of the software application.

17. A computer-readable medium including computer-executable instructions facilitating establishing a high-quality network connection communications session between a software application running on a subscriber computer and a network service provider, the computer-executable instructions performing the steps of:
receiving a request for a high-quality network connection on behalf of the subscriber computer, the request caused by a system quality proxy agent residing on either the subscriber computer or a content server contacted by the subscriber computer, the proxy agent having obtained a quality profile for the software application, and the request comprising information about the software application;
authenticating the request;
obtaining policy information corresponding to the request; and
granting a high-quality network connection communications session to the subscriber computer for communications with the application according to the policy information.

18. The computer-readable medium of claim 17 wherein the quality of the communications session is measured according to a combination of one or more of bandwidth, latency and jitter.

19. The computer-readable medium of claim 17, the computer-executable instructions further performing the step of:
marking communications packets in the high-quality communications session with a TOS/DS mark for designating the priority of communications packets in the session.

20. The computer-readable medium of claim 17 wherein the system quality proxy agent performs the steps of;
capturing a network call from the software application running on the subscriber computer;
identifying the software application associated with making the network call;
verifying that the software application is authorized to request a high-quality network connection; and
causing to be transmitted to the network service provider the request for a high-quality network connection communications session according to the quality profile.

21. A system for managing the quality of a network connection communications session provided to an application running on the computer of a subscriber of a network service provider, the system comprising:
a database containing information about the subscriber of the network service provider;
a policy server storing network quality configuration settings for a variety of conditions; and
an application manager, in response to a request from a quality proxy agent running on the subscriber's computer, reading from the database and instructing the policy server to establish a network connection communications session with the application running on the subscriber computer at a quality according to an appropriate configuration setting;
wherein the request from the quality proxy agent is made according to a quality profile for the application, the profile obtained by the quality proxy agent for the application.

22. The system of claim 21 wherein the quality of the communications session is measured according to a combination of one or more of bandwidth, latency and jitter.

23. The system of claim 21 further comprising a billing system in connection with the policy server for ensuring the subscriber is billed appropriately for the quality communications session provided.

24. A method for increasing the revenue of a network service provider, the network service provider providing network service to a plurality of customers, the method comprising:
receiving from a requesting entity, on behalf of a computing device associated with a customer in the plurality of customers, a request for a high-quality network connection communications session for an application running on the computing device, wherein the request is in accordance with a quality profile for the application, the profile obtained by the requesting entity;
causing network communications for the application to be of a higher quality than ordinary network communications; and
billing the customer a fee for services including high-quality network connection communications sessions.

25. The method of claim 24 wherein the requesting entity is a system quality proxy agent running independently from the application on the computing device associated with the customer, and the request comprises information about the customer and the application.

26. The method of claim 4 wherein the object is a software application running on the subscriber computer.

27. The method of claim 26 wherein the subscriber computer is in a peer-to-peer communication session with a software application running on a computer of a second subscriber, and wherein communications between the software application on the first subscriber's computer and the network service provider are of a quality further satisfying requirements for the software application running on the computer of the second subscriber.

28. The method of claim 4 wherein the object is a device connected to the subscriber computer over a local network.

29. The method of claim 28 wherein the device is a digital video recorder or gaming console.

30. The method of claim 26 whereby, after the network service provider has processed the request, the number of gates used for communications between the subscriber computer and the network service provider is reduced.

31. The method of claim 13 further comprising:
reducing the number of gates used for communications between the subscriber computer and the network service provider.

32. The system of claim 21 wherein the computer of the subscriber is in a peer-to-peer communication session with an application running on a computer of a second subscriber, and wherein the appropriate configuration setting comprises quality requirements for the application running on the computer of the second subscriber.

33. The system of claim 21, the application manager further causing the number of gates used for communicating between the subscriber computer and the network service provider to be reduced.

34. A data structure for use in a session initiation protocol and session description protocol for managing the quality of a network connection communications session provided to an application running on the computer of a subscriber of a network service provider, the data structure comprising:
fields for describing characteristics of the communications session; and
an application field for describing the application running on the computer.

35. The data structure of claim 34 further comprising:
a profile field for describing a category of the type of information to be transferred during the provided managed quality communications session.
